(19) United States
(12) Patent Application Publication
(10) Pub. No.: US 2025/0226911 A1
(43) Pub. Date: Jul. 10, 2025

(54) SIGNALING DESIGNS FOR UNEQUAL MODULATION AND MODULATION AND CODING SCHEME (MCS) INDICATION

(71) Applicant: QUALCOMM Incorporated, San Diego, CA (US)

(72) Inventors: Jialing Li CHEN, San Diego, CA (US); Sameer VERMANI, San Diego, CA (US); Bin TIAN, San Diego, CA (US)

(21) Appl. No.: 18/677,248

(22) Filed: May 29, 2024

Related U.S. Application Data
(60) Provisional application No. 63/618,983, filed on Jan. 9, 2024.

(51) Int. Cl. H04L 1/00; H04L 27/00; H04L 27/34

(52) U.S. Cl. CPC H04L 1/0003; H04L 27/0008; H04L 27/34

(57) ABSTRACT

This disclosure provides methods, components, devices and systems for signaling designs for unequal modulation and modulation and coding scheme (MCS) indication. Some aspects more specifically relate to user info field designs to support such an unequal modulation indication and/or an MCS indication, including designs for user info fields of multi-user (MU) physical layer (PHY) protocol data units (PPDUs) and of Trigger frames. In some examples, an access point (AP) may configure a user info field to include at least five bits for MCS signaling, which may enable the AP to uniquely identify an MCS from a set of greater than 16 MCSs. Additionally, or alternatively, the AP may configure a user info field to include a subfield indicative of a pattern of modulation schemes (such as an equal modulation or an unequal modulation) across a set of spatial streams allocated for communication between the AP and a station (STA).

### PRIORITY INFORMATION

The present Application for Patent claims priority under 35 U.S.C. § 119 to U.S. Provisional Patent Application No. 63/618,983 by CHEN et al., filed Jan. 9, 2024, and entitled “SIGNALING DESIGNS FOR UNEQUAL MODULATION AND MODULATION AND CODING SCHEME (MCS) INDICATION,” which is assigned to the assignee hereof and hereby expressly incorporated by reference herein.

### TECHNICAL FIELD

This disclosure relates generally to wireless communication and, more specifically, to signaling designs for (un) equal modulation and/or modulation and coding scheme (MCS) indication.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, an AP and a STA may communicate using a modulation and coding scheme (MCS). An MCS may correspond to a combination of a modulation (such as a modulation scheme) and a code rate. In other words, different MCSs may correspond to different combinations of modulations and code rates. An MCS may relate to how many useful bits can be transmitted via each resource element (RE). To communicate successfully (such as for successful demodulation and decoding), an AP and a STA may strive to use a same MCS. For example, if an AP uses a first MCS as part of transmitting (encoding and modulating) a data message and a STA uses a second MCS as part of receiving (demodulating and decoding) the data message, the reception at the STA will likely fail. An AP may indicate an MCS, from a set of available MCSs, via a user info field associated with a STA with which the AP expects to communicate using that MCS. To indicate the MCS, the AP may set an MCS subfield of the user info field to a specific codepoint that corresponds to an index of the MCS. In some systems, however, APs and STAs may support additional capabilities related to MCSs, which some current user info fields may be unable to support.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless communication device. The first wireless communication device may include a processing system that includes processor circuitry and memory circuitry that stores code. The processing system may be configured to cause the first wireless communication device to transmit, via one or more subfields of a user info field associated with a second wireless communication device, information indicative of a modulation and coding scheme (MCS), from a set of multiple MCSs, associated with communication between the first wireless communication device and the second wireless communication device, where the one or more subfields collectively include at least five bits, and communicate with the second wireless communication device in accordance with the MCS.

Another innovative aspect of the subject matter described in this disclosure can be implemented in a method for wireless communication by a first wireless communication device. The method may include transmitting, via one or more subfields of a user info field associated with a second wireless communication device, information indicative of an MCS, from a set of multiple MCSs, associated with communication between the first wireless communication device and the second wireless communication device, where the one or more subfields collectively include at least five bits, and communicating with the second wireless communication device in accordance with the MCS.

Another innovative aspect of the subject matter described in this disclosure can be implemented in a first wireless communication device. The first wireless communication device may include means for transmitting, via one or more subfields of a user info field associated with a second wireless communication device, information indicative of an MCS, from a set of multiple MCSs, associated with communication between the first wireless communication device and the second wireless communication device, where the one or more subfields collectively include at least five bits, and means for communicating with the second wireless communication device in accordance with the MCS.

Another innovative aspect of the subject matter described in this disclosure can be implemented in a non-transitory computer-readable medium storing code for wireless communication by a first wireless communication device. The code may include instructions executable by one or more processors to transmit, via one or more subfields of a user info field associated with a second wireless communication device, information indicative of an MCS, from a set of multiple MCSs, associated with communication between the first wireless communication device and the second wireless communication device, where the one or more subfields collectively include at least five bits, and communicate with the second wireless communication device in accordance with the MCS.

In some examples of the method, first wireless communication devices, and non-transitory computer-readable medium described herein, a first subset of the at least five bits may be indicative of a code rate associated with the MCS and a second subset of the at least five bits may be indicative of a modulation associated with the MCS.

In some examples of the method, first wireless communication devices, and non-transitory computer-readable medium described herein, the one or more subfields include a first subfield and a second subfield and the first subfield includes the first subset of the at least five bits and the second subfield includes the second subset of the at least five bits.

In some examples of the method, first wireless communication devices, and non-transitory computer-readable medium described herein, a first subset of the at least five bits may be indicative of a range of MCS indices within which an index corresponding to the MCS may be located and a second subset of the at least five bits may be indicative of the MCS with respect to the range of MCS indices and the range of MCS indices corresponds to a subset of the set of multiple MCSs.

In some examples of the method, first wireless communication devices, and non-transitory computer-readable medium described herein, the one or more subfields consists of a single subfield and the single subfield includes the first subset of the at least five bits and the second subset of the at least five bits.

In some examples of the method, first wireless communication devices, and non-transitory computer-readable medium described herein, the one or more subfields include a first subfield and a second subfield and the first subfield includes the first subset of the at least five bits and the second subfield includes the second subset of the at least five bits.

Another innovative aspect of the subject matter described in this disclosure can be implemented in a first wireless communication device. The first wireless communication device may include a processing system that includes processor circuitry and memory circuitry that stores code. The processing system may be configured to cause the first wireless communication device to transmit, via a user info field associated with a second wireless communication device, information indicative of a pattern of modulation schemes associated with communication between the first wireless communication device and the second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and communicate with the second wireless communication device in accordance with the pattern of modulation schemes.

Another innovative aspect of the subject matter described in this disclosure can be implemented in a method for wireless communication by a first wireless communication device. The method may include transmitting, via a user info field associated with a second wireless communication device, information indicative of a pattern of modulation schemes associated with communication between the first wireless communication device and the second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and communicating with the second wireless communication device in accordance with the pattern of modulation schemes.

Another innovative aspect of the subject matter described in this disclosure can be implemented in a first wireless communication device. The first wireless communication device may include means for transmitting, via a user info field associated with a second wireless communication device, information indicative of a pattern of modulation schemes associated with communication between the first wireless communication device and the second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and means for communicating with the second wireless communication device in accordance with the pattern of modulation schemes.

Another innovative aspect of the subject matter described in this disclosure can be implemented in a non-transitory computer-readable medium storing code for wireless communication by a first wireless communication device. The code may include instructions executable by one or more processors to transmit, via a user info field associated with a second wireless communication device, information indicative of a pattern of modulation schemes associated with communication between the first wireless communication device and the second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and communicate with the second wireless communication device in accordance with the pattern of modulation schemes.

In some examples of the method, first wireless communication devices, and non-transitory computer-readable medium described herein, the user info field includes a first subfield that indicates a quantity of the set of multiple spatial streams and a second subfield that indicates the pattern of modulation schemes.

In some examples of the method, first wireless communication devices, and non-transitory computer-readable medium described herein, the second subfield may be interpreted in accordance with the quantity of the set of multiple spatial streams.

In some examples of the method, first wireless communication devices, and non-transitory computer-readable medium described herein, the user info field includes a subfield that jointly indicates a quantity of the set of multiple spatial streams and the pattern of modulation schemes.

In some examples of the method, first wireless communication devices, and non-transitory computer-readable medium described herein, the subfield includes a set of bits and each respective permutation of the set of bits indicates a respective quantity of the set of multiple spatial streams and a respective pattern of modulation schemes across the set of multiple spatial streams.

Another innovative aspect of the subject matter described in this disclosure can be implemented in a first wireless communication device. The first wireless communication device may include a processing system that includes processor circuitry and memory circuitry that stores code. The processing system may be configured to cause the first wireless communication device to receive, via one or more subfields of a user info field associated with the first wireless communication device, information indicative of an MCS, from a set of multiple MCSs, associated with communication between the first wireless communication device and a second wireless communication device, where the one or more subfields collectively include at least five bits, and communicate with the second wireless communication device in accordance with the MCS.

Another innovative aspect of the subject matter described in this disclosure can be implemented in a method for wireless communication by a first wireless communication device. The method may include receiving, via one or more subfields of a user info field associated with the first wireless communication device, information indicative of an MCS, from a set of multiple MCSs, associated with communication between the first wireless communication device and a second wireless communication device, where the one or more subfields collectively include at least five bits, and communicating with the second wireless communication device in accordance with the MCS.

Another innovative aspect of the subject matter described in this disclosure can be implemented in a first wireless communication device. The first wireless communication device may include means for receiving, via one or more subfields of a user info field associated with the first wireless communication device, information indicative of an MCS, from a set of multiple MCSs, associated with communication between the first wireless communication device and a second wireless communication device, where the one or more subfields collectively include at least five bits, and means for communicating with the second wireless communication device in accordance with the MCS.

Another innovative aspect of the subject matter described in this disclosure can be implemented in a non-transitory computer-readable medium storing code for wireless communication by a first wireless communication device. The code may include instructions executable by one or more processors to receive, via one or more subfields of a user info field associated with the first wireless communication device, information indicative of an MCS, from a set of multiple MCSs, associated with communication between the first wireless communication device and a second wireless communication device, where the one or more subfields collectively include at least five bits, and communicate with the second wireless communication device in accordance with the MCS.

In some examples of the method, first wireless communication devices, and non-transitory computer-readable medium described herein, a first subset of the at least five bits may be indicative of a code rate associated with the MCS and a second subset of the at least five bits may be indicative of a modulation associated with the MCS.

In some examples of the method, first wireless communication devices, and non-transitory computer-readable medium described herein, the one or more subfields include a first subfield and a second subfield and the first subfield includes the first subset of the at least five bits and the second subfield includes the second subset of the at least five bits.

In some examples of the method, first wireless communication devices, and non-transitory computer-readable medium described herein, a first subset of the at least five bits may be indicative of a range of MCS indices within which an index corresponding to the MCS may be located and a second subset of the at least five bits may be indicative of the MCS with respect to the range of MCS indices and the range of MCS indices corresponds to a subset of the set of multiple MCSs.

In some examples of the method, first wireless communication devices, and non-transitory computer-readable medium described herein, the one or more subfields consists of a single subfield and the single subfield includes the first subset of the at least five bits and the second subset of the at least five bits.

In some examples of the method, first wireless communication devices, and non-transitory computer-readable medium described herein, the one or more subfields include a first subfield and a second subfield and the first subfield includes the first subset of the at least five bits and the second subfield includes the second subset of the at least five bits.

Another innovative aspect of the subject matter described in this disclosure can be implemented in a first wireless communication device. The first wireless communication device may include a processing system that includes processor circuitry and memory circuitry that stores code. The processing system may be configured to cause the first wireless communication device to receive, via a user info field associated with the first wireless communication device, information indicative of a pattern of modulation schemes associated with communication between the first wireless communication device and a second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and communicate with the second wireless communication device in accordance with the pattern of modulation schemes.

Another innovative aspect of the subject matter described in this disclosure can be implemented in a method for wireless communication by a first wireless communication device. The method may include receiving, via a user info field associated with the first wireless communication device, information indicative of a pattern of modulation schemes associated with communication between the first wireless communication device and a second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and communicating with the second wireless communication device in accordance with the pattern of modulation schemes.

Another innovative aspect of the subject matter described in this disclosure can be implemented in a first wireless communication device. The first wireless communication device may include means for receiving, via a user info field associated with the first wireless communication device, information indicative of a pattern of modulation schemes associated with communication between the first wireless communication device and a second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and means for communicating with the second wireless communication device in accordance with the pattern of modulation schemes.

Another innovative aspect of the subject matter described in this disclosure can be implemented in a non-transitory computer-readable medium storing code for wireless communication by a first wireless communication device. The code may include instructions executable by one or more processors to receive, via a user info field associated with the first wireless communication device, information indicative of a pattern of modulation schemes associated with communication between the first wireless communication device and a second wireless communication device, where the pattern of modulation schemes corresponds to an equal modulation pattern comprising same types of modulation across a set of multiple spatial streams or an unequal modulation pattern comprising different types of modulation across the set of multiple spatial streams with a common code rate, and communicate with the second wireless communication device in accordance with the pattern of modulation schemes.

In some examples of the method, first wireless communication devices, and non-transitory computer-readable medium described herein, the user info field includes a first subfield that indicates a quantity of the set of multiple spatial streams and a second subfield that indicates the pattern of modulation schemes.

In some examples of the method, first wireless communication devices, and non-transitory computer-readable medium described herein, the second subfield may be interpreted in accordance with the quantity of the set of multiple spatial streams.

In some examples of the method, first wireless communication devices, and non-transitory computer-readable medium described herein, the user info field includes a subfield that jointly indicates a quantity of the set of multiple spatial streams and the pattern of modulation schemes.

In some examples of the method, first wireless communication devices, and non-transitory computer-readable medium described herein, the subfield includes a set of bits and each respective permutation of the set of bits indicates a respective quantity of the set of multiple spatial streams and a respective pattern of modulation schemes across the set of multiple spatial streams.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example signaling diagram that supports signaling designs for modulation and coding scheme (MCS) indication.

FIG. 3 shows an example signaling diagram that supports signaling designs for (un) equal modulation indication.

FIGS. 4-6 show example user info field formats in multi-user (MU) physical layer (PHY) protocol data units (PPDUs) that support signaling designs for (un) equal modulation and/or MCS indication.

FIG. 7 shows an example user info field format in a Trigger frame that supports signaling designs for (un) equal modulation and/or MCS indication.

FIG. 8 shows example subfield formats that support signaling designs for (un) equal modulation indication.

FIG. 9 shows an example process flow that supports signaling designs for (un) equal modulation and/or MCS indication.

FIG. 10 shows a block diagram of an example wireless communication device that supports signaling designs for (un) equal modulation and/or MCS indication.

FIG. 11 shows a block diagram of an example wireless communication device that supports signaling designs for (un) equal modulation and/or MCS indication.

FIGS. 12-19 show flowcharts illustrating example processes performable by or at a first wireless communication device that supports signaling designs for (un) equal modulation and/or MCS indication.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to signaling designs for (un) equal modulation indication and/or modulation and coding scheme (MCS) indication in ultra-high reliability (UHR) networks. Some aspects more specifically relate to user info field designs to support such an unequal modulation indication and/or an MCS indication, including designs for user info fields of multi-user (MU) physical layer (PHY) protocol data units (PPDUs) and designs for user info fields of Trigger frames. In some examples, an access point (AP) may configure a user info field to include at least five bits for MCS signaling, which may enable the AP to uniquely identify an MCS from a set of greater than 16 MCSs (as UHR networks may use MCSs in addition to those supported in other networks, such as in addition to 16 MCSs supported in some extremely high throughput (EHT) networks). In such examples, the five bits may include a first subset of bits and a second subset of bits. In some implementations, the first subset of bits may indicate a code rate associated with an MCS and the second subset of bits may indicate a modulation scheme associated with the MCS. In some other implementations, the first subset of bits may indicate a range of MCS indices within which an MCS is located and the second subset of bits may indicate the MCS with respect to the indicated range of MCS indices. Additionally, or alternatively, the AP may configure a user info field to include a subfield indicative of a pattern of modulation schemes (such as an equal modulation pattern or an unequal modulation pattern) across a set of spatial streams allocated for communication between the AP and a station (STA). In some implementations, the user info field may include a first subfield indicative of a quantity of spatial streams and a second subfield indicative of the pattern of modulation schemes. In some other implementations, the user info field may include a subfield that jointly indicates the quantity of spatial streams and the pattern of modulation schemes. Additional aspects of the present disclosure relate to various user info field modifications to accommodate such 5-bit MCS indications and/or such unequal modulation indications.

Particular aspects of the subject matter described in this disclosure can be implemented to realize one or more of the following potential advantages. In some examples, by supporting a 5-bit MCS indication, the described techniques can be used to uniquely (such as accurately and individually) indicate an MCS from a set of UHR MCSs, which may exceed 16 in quantity. In accordance with such an ability to uniquely indicate an MCS from a set of greater than 16 MCSs via the user info field designs disclosed herein, wireless communication systems may define and support additional MCSs (such as in addition to EHT MCSs) with relatively minimal disruption to frame generation and construction, which may enable relatively simple frame organization and maintain a relatively low signaling overhead while allowing for growth in the quantity of supported MCSs. Further, in accordance with using different subsets of a 5-bit MCS indication to serve different roles in MCS indication, the described techniques may be implemented to provide more flexibility for introduction of additional MCSs over time, or for using MCS bits for other uses, by way of employing separate indications of code rate and modulation scheme. Moreover, in accordance with using different subsets of a 5-bit MCS indication to serve different roles in MCS indication, the described techniques may be implemented to facilitate simpler STA parsing by way of enabling a 4-bit MCS field interpretation to point to an MCS within an indicated range of MCSs.

Additionally, in some examples, by supporting an indication of a pattern of modulation schemes via a user info field, an AP and a STA may leverage unequal modulation to dynamically increase data rates and/or increase communication reliability by providing subfields and/or interpretations of subfields via which the AP and the STA can indicate a specific unequal modulation pattern. In examples in which a user info field separately indicates a quantity of spatial streams and a pattern of modulation schemes, the described techniques may be implemented to provide greater flexibility by way of providing relatively more codepoints via which spatial information can be indicated. Further, in examples in which a user info field jointly indicates a quantity of spatial streams and a pattern of modulation schemes, the described techniques may be implemented to maintain relatively low signaling overhead while still achieving a mutual understanding of a specific pattern of modulation schemes by way of supporting defined interpretations according to which an AP and a STA can indicate a specific unequal modulation pattern. In accordance with the example implementations of the present disclosure, systems may more robustly support an increasing quantity of MCSs and/or unequal modulation patterns, which may support greater communication reliability, higher data rates and/or system throughput, greater system capacity, and/or greater spectral efficiency, among other benefits, by way of facilitating adoption of greater quantities of MCSs and/or unequal modulation techniques.

Moreover, a wireless communication device may leverage, deploy, or otherwise use (such as communicate in accordance with) a new MCS (such as additional MCSs beyond EHT MCS0-15) and/or unequal modulation to improve a rate vs. range (RvR) tradeoff, which may further increase a data rate and/or system capacity while balancing communication range, or vice versa, or may enable a more efficient and/or a more dynamic toggle between data rate and communication range. For example, by communicating in accordance with a “new” or UHR MCS, a wireless communication device may improve RvR in a single spatial stream (1ss) and/or in multiple spatial streams with equal modulation by selecting (and accurately indicating) an MCS that is relatively more suited to current, measured, and/or estimated channel conditions from a set of relatively more granular MCS options (such as from a set of relatively more MCS options). Use of a relatively more suitable MCS may increase data rates or communication range and/or enable a prioritization of one over the other in accordance with current channel conditions. For further example, by communicating in accordance with an indicated pattern of modulation schemes (such as an unequal modulation scheme), a wireless communication device may improve RvR in multiple spatial streams in beamformed transmission (TxBF) and/or in open loop (OL) transmission. In scenarios of OL transmission, wireless communication devices may exchange (such as transmit and/or receive) channel quality feedback (such as channel quality indicator (CQI) feedback, and/or such as relatively more channel quality feedback as compared to in scenarios of TxBF) to realize unequal modulation gain. In such scenarios, a wireless communication device may select a specific pattern of modulation schemes in accordance with measured channel conditions across one or multiple spatial streams. In some examples, (UHR) MCS selection and/or indication may boost unequal modulation gain.

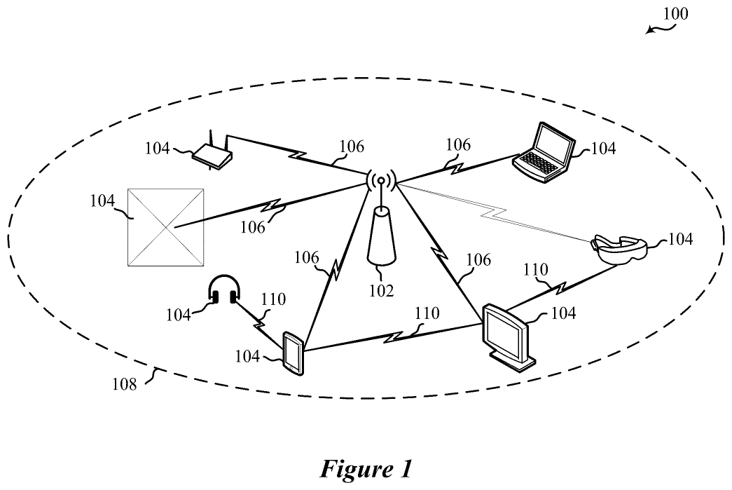

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless AP 102 and any number of wireless STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the PHY and MAC layers. The AP 102 and STAs 104 transmit and receive wireless communication (hereinafter also referred to as “Wi-Fi communication” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands used by Wi-Fi technology, such as the 2.4 GHz, 5 GHZ, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands. In some examples, multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). In some examples, any transmission by an AP 102 or a STA 104 within a BSS may involve transmission on the primary 20 MHz channel. As such, in some systems, the transmitting device may contend on and win a TXOP on the primary channel to transmit anything at all. However, some APs 102 and STAs 104 supporting UHR communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Transmitting and receiving devices AP 102 and STA 104 may support the use of various MCSs to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-QAM. In some examples, a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs within each OFDM symbol). The AP 102 or the STA 104 using 4096-QAM may enable a 20% increase in data rate compared to 1024-QAM given the same coding rate, thereby allowing users to obtain higher transmission efficiency.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

In some implementations, the AP 102 and STAs 104 can support various multi-user communication; that is, concurrent transmissions from one device to each of multiple devices (for example, multiple simultaneous downlink communication from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may enable multiple STAs 104 to send UL traffic to the AP 102 concurrently in time. A trigger frame may address one or more STAs 104 through respective AIDs, and may assign each AID (and each STA 104) one or more RUs that can be used to send UL traffic to the AP 102. The AP also may designate one or more random access (RA) RUs that unscheduled STAs 104 may contend for.

In some wireless communication systems, an AP 102 may allocate or assign multiple RUs to a single STA104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU, such as MRU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured, which may increase spectrum efficiency and flexibility.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in an MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

In some wireless communication systems, such as wireless communication systems complying with the 802.11be standard amendment, wireless communication devices may support 16 MCSs, each MCS corresponding to a specific (such as different) combination of a code rate and a modulation (which may be equivalently referred to as a modulation scheme). A definition of each of the 16 supported MCSs is illustrated by Table 1, shown below. As illustrated by Table 1, each MCS index (which indicates or identifies an MCS) corresponds to a respective code rate, a respective modulation, and is either applicable or not applicable to a duplication (DUP) mode. The various types of modulation schemes to which an MCS might correspond include binary phase shift keying (BPSK), quadrature phase shift keying (QPSK), various sub-types of quadrature amplitude modulation (QAM), and/or dual carrier modulation (DCM). In accordance with DCM, a wireless communication device may modulate same information on a pair of subcarriers. A wireless communication device may use DCM along with another type of modulation (such as another modulation scheme), such as BPSK. For example, a wireless communication device may use both BPSK and DCM to (de) modulate data, with such a combination of BPSK and DCM referred to herein as BPSK-DCM. For BPSK with DCM, a wireless communication device may obtain modulated signals for two different carriers (such as for two different sub-carriers) by mapping an encoded bit on two identical or different BPSK constellations. A specific MCS may be denoted by its index, such that a first MCS may be denoted as MCS0, a second MCS may be denoted as MCS1, and so on. The 16 available MCSs may span a range of or otherwise be referred to as MCS0 through MCS15 (MCS0-15). In some aspects, the MCS0-15 illustrated by Table 1 may be understood as EHT MCSs, such as EHT MCS0-15.

TABLE 1
Supported MCSs in 802.11be

| MCS | Code | | DUP |
|---|---|---|---|
| Index | Rate | Modulation | Mode |
| 0 | 1/2 | BPSK | No |
| 1 | 1/2 | QPSK | No |
| 2 | 3/4 | QPSK | No |
| 3 | 1/2 | 16 QAM | No |
| 4 | 3/4 | 16 QAM | No |
| 5 | 2/3 | 64 QAM | No |
| 6 | 3/4 | 64 QAM | No |
| 7 | 5/6 | 64 QAM | No |
| 8 | 3/4 | 256 QAM | No |
| 9 | 5/6 | 256 QAM | No |
| 10 | 3/4 | 1024 QAM | No |
| 11 | 5/6 | 1024 QAM | No |
| 12 | 3/4 | 4096 QAM | No |
| 13 | 5/6 | 4096 QAM | No |
| 14 | 1/2 | BPSK-DCM | Yes |
| 15 | 1/2 | BPSK-DCM | No |

Wireless communication devices may use MCS0-13 for any configuration, may use MCS14 (rate 1/2, BPSK-DCM in DUP mode) for (only) 1ss in an EHT DUP mode, and may use MCS15 (rate 1/2, BPSK-DCM) for (only) 1ss. To indicate one of the 16 available MCSs, a wireless communication device (such as an AP 102 or a STA 104) may include a 4-bit MCS field in each of one or more user info fields to indicate an MCS for a user (such as a STA 104) associated with that user info field. The wireless communication device may include such a 4-bit MCS field in user info fields of an EHT MU PPDU. In an user info field format associated with a non-MU-MIMO allocation, all 16 MCSs may be available for use. In a user info field format associated with an MU-MIMO allocation, MCS0-13 may be available for use (with MCS14 and MCS15 unavailable for use). Similarly, in a Trigger frame, a wireless communication device may include a 4-bit uplink (sometimes referred to herein as “UL”) EHT-MCS field in an EHT variant user info field and may use the 4-bit UL EHT-MCS field to indicate an MCS for a user (such as a STA 104) associated with the EHT variant user info field. In either example (such as if included in an EHT MU PPDU or a Trigger frame), the 4-bit field may indicate an MCS index (such as an EHT-MCS index) of the MCS indices listed in Table 1.

In some wireless communication systems, such as UHR systems or systems complying with the 802.11bn standard amendment, wireless communication devices (such as one or more APs and/or one or more STAs 104) may employ additional MCSs on top of (such as in addition to) the 16 supported (baseline) MCSs. For example, while some legacy wireless communication systems may use any one of MCS0-15, some other wireless communication systems may support MCSs in addition to MCS0-15, such as an MCS16, an MCS17, and so on. For example, MCSs in addition to of MCS0-15 may include an MCS associated with a code rate of 2/3 and a modulation of QPSK, an MCS associated with a code rate of 2/3 and a modulation of 16QAM, an MCS associated with a code rate of 5/6 and a modulation 16QAM, and/or an MCS associated with a code rate of 2/3 and a modulation of 256QAM. Further, such additional MCSs may be associated with other code rates not associated with any of MCS0-15, such as a code rate of 7/8.

In systems that employ any of such MCSs in addition to MCS0-15, some MCS indication techniques may be insufficient. For example, a wireless communication device may be able to use a 4-bit MCS field to individually indicate any one of MCS0-15 because a 4-bit field has 16 unique permutations, but may not be able to use a 4-bit MCS field to individually indicate an MCS from a set of MCSs greater than 16. In other words, a size of the MCS field in some systems may become a limiting factor to how many MCSs a system can support and/or may cause ambiguity between two or more wireless communication devices if a specific MCS is unable to indicated via an MCS field in a user info field.

Additionally, or alternatively, some wireless communication systems, such as UHR systems or systems complying with the 802.11bn standard amendment, may support an unequal modulation technique (which also may be referred to as unequal QAM) with joint encoding across multiple streams in MIMO communication. For example, such systems may employ unequal modulation designs for two spatial streams (2ss), three spatial streams (3ss), and/or four spatial streams (4ss). Unequal modulation may refer to how a wireless communication device uses potentially different (or at least separately indicated) types of modulations to (de) modulate different spatial streams with a common code rate. For example, a wireless communication device may use a first modulation scheme for (de) modulation of a first spatial stream and may use a second modulation scheme for (de) modulation of a second spatial stream and may use a single code rate for encoding/decoding both the first spatial stream and the second spatial stream. In other words, for a particular number of spatial streams (Nss), which may be indicative of a numerical quantity of spatial streams, a wireless communication device may jointly encode all spatial streams with a common (such as a same) code rate and may use different modulation orders for different spatial streams.

In some aspects, wireless communication devices may employ unequal modulation for non-MU-MIMO allocations and may refrain from employing unequal modulation for MU-MIMO allocations. Some systems may support up to three unequal modulation (such as unequal QAM) variation patterns for each Nss. A pattern of modulations may be within a set of available design options, such as from a set of available or possible patterns of modulations. An example set of available or possible patterns of modulations for each Nss (from 2ss-4ss) is illustrated by Table 2, shown below. Each QAM variation pattern of a particular Nss is presented in a form of, for example, (QAM/QAM-x/QAM-y) for Nss=3 spatial streams, meaning, modulation of QAM is being used for the first spatial stream, modulation of x QAM level down is being used for the second spatial stream, and modulation of y QAM level down is being used for the third spatial stream. In some examples, y>=x>=0. The modulation level goes up in the order of BPSK, QPSK, 16QAM, 64QAM, 256QAM, 1 kQAM, 4 kQAM, and so on, going up, with 1 level difference in between each pair of adjacent modulation levels. The modulation level goes down in the reverse order. For example, BPSK-DCM may be viewed as 1 level down from BPSK. For further example, QAM-1 may correspond to a modulation scheme associated with the next smallest index relative to a QAM associated with an MCS indicated by a user info field, QAM-2 may correspond to a modulation scheme associated with an index two indices lower than the QAM associated with the MCS indicated by the user info field, and so on.

TABLE 2
Example Patterns of Modulation Schemes

| Scenario | Unequal QAM Design Options |
|---|---|
| 2ss | 2 patterns (QAM/QAM-1) & (QAM/QAM-2) |
| 3ss | Option 1: 2 patterns (QAM/QAM/QAM-1) & (QAM/QAM/QAM-2) |
| | Option 2: 3 patterns (QAM/QAM/QAM-1), (QAM/QAM/QAM-2) & |
| | (QAM/QAM-1/QAM-2) |
| 4ss | Option 1: 2 patterns (QAM/QAM/QAM/QAM-1) & (QAM/QAM/QAM/QAM-2) |
| | Option 2: 3 patterns (QAM/QAM/QAM/QAM-1), (QAM/QAM/QAM/QAM-2) & |
| | (QAM/QAM/QAM-1/QAM-2) |

Further, some systems may align, correlate, set, or configure the modulation variation pattern in accordance with a quality of the spatial streams. In some implementations, for example, if spatial streams are ordered in a signal-to-interference-plus-noise ratio (SINR) non-increasing order, a wireless communication device may set or configure a modulation pattern such that the modulation order is in non-increasing order for the spatial stream indices. For instance, if a set of spatial streams are ordered in SINR non-increasing order, a modulation pattern may indicate that a wireless communication device uses QAM for a first spatial stream and uses a same or lower QAM for subsequent spatial streams. In TxBF, wireless communication devices may assume or expect that spatial streams are ordered in SINR non-increasing order and, likewise, a pattern of modulation schemes can also be in non-increasing order. In OL, wireless communication devices may assume or expect that a transmitter can permute columns of a precoding matrix so as to arrange the modulation of spatial streams in SINR non-increasing order. In some other implementations, and in either TxBF or OL, wireless communication devices may order spatial streams in an SINR non-decreasing order and may set or configure (or assume or expect) that the modulation order is also in a non-decreasing order for the spatial stream indices.

Further, an unequal modulation variation pattern may be in the form of using any one of multiple spatial streams as an anchor (such as an anchor spatial stream with an anchor modulation scheme or an anchor MCS). For example, a wireless communication device may use a relatively stronger spatial stream (such as a spatial stream with a relatively larger SINR as compared to another spatial stream) as an anchor spatial stream. In such examples, and in an example 2ss scenario, a pattern of modulation schemes may take the form of (QAM/QAM-1), meaning the second spatial stream uses one QAM level below the modulation used for the first spatial stream (such as one QAM level below an anchor modulation scheme used for the first spatial stream, the first spatial stream being the anchor spatial stream). In some other examples, a wireless communication device may use a relatively weaker spatial stream (such as a spatial stream with a relatively lower SINR as compared to another spatial stream) as an anchor spatial stream. In such examples, and in an example 2ss scenario, a pattern of modulation schemes may take the form of (QAM+1/QAM), meaning the first spatial stream uses one QAM level above the modulation used for the second spatial stream (such as one QAM level above an anchor modulation scheme used for the second spatial stream, the second spatial stream being the anchor spatial stream). In other words, a wireless communication device may use any spatial stream of a set of spatial streams as an anchor spatial stream and may set or configure a pattern of modulation schemes from the anchor spatial stream (such that a modulation scheme associated with an anchor spatial stream may be understood as an anchor modulation scheme). In examples in which an MCS is indicated or used as an anchor MCS, the corresponding modulation scheme may be an anchor modulation scheme and the corresponding coding rate may be the coding rate that the wireless communication device uses to jointly encode all spatial streams.

In systems that may employ such an unequal pattern of modulation schemes, some signaling designs may be insufficient. In other words, some systems may lack a signaling mechanism according to which two or more wireless communication devices can indicate a specific pattern of modulation schemes. For example, some user info field designs may lack a field or interpretation via which a wireless communication device can indicate, identify, ascertain, or otherwise determine a pattern of modulation schemes.

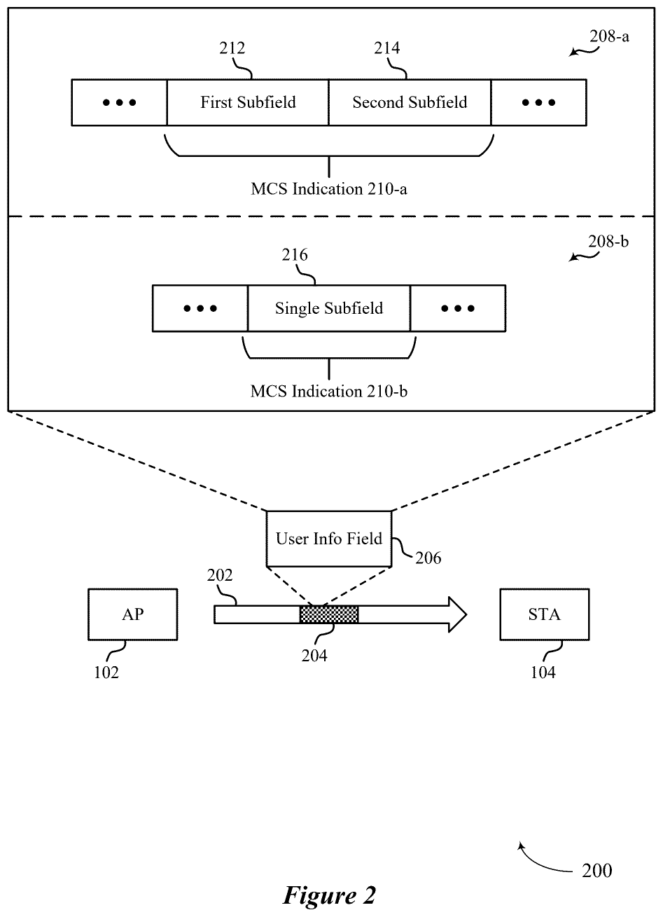

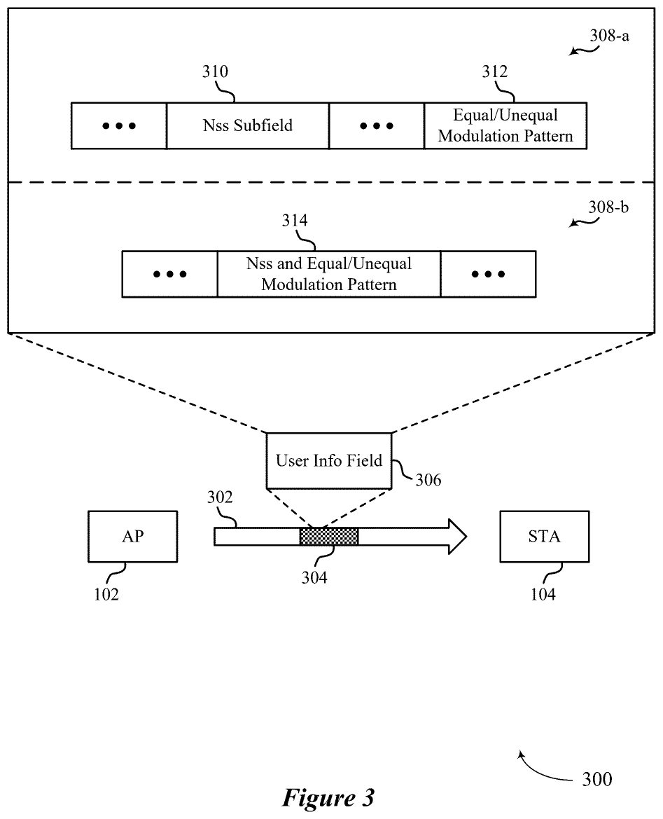

In some implementations, two or more wireless communication devices may support one or more signaling mechanisms according to which the wireless communication devices may indicate an MCS from a set of MCSs including MCSs defined in addition to MCS0-15 and/or a pattern of modulation schemes. In some examples, the wireless communication devices may support such indications via a user info field, such as via one or more subfields of a user info field. For example, a first wireless communication device may transmit, via one or more subfields of a user info field associated with a second wireless communication device, information indicative of an MCS and/or a pattern of modulation schemes. The first wireless communication device may transmit a frame or a PPDU (such as a packet) including the user info field. The user info field may be associated with the second wireless communication device by way of including, in an AID subfield of the user info field, an identifier (ID) corresponding to, indicative of, or otherwise associated with the second wireless communication device. In some implementations, the one or more subfields that provide the indication of the MCS may include at least 5 bits. Additional details related to the MCS indication via a user info field are illustrated by and described with reference to FIG. 2 and additional details related to the indication of the pattern of modulation schemes are illustrated by and described with reference to FIG. 3.

FIG. 2 shows an example signaling diagram 200 that supports signaling designs for MCS indication. The signaling diagram 200 may implement or be implemented to realize aspects of the wireless communication network 100. For example, the signaling diagram 200 illustrates communication between an AP 102 and a STA 104, which may be examples of corresponding devices as described with reference to FIG. 1.

In some implementations, the AP 102 may transmit, to the STA 104 via a communication link 202, a downlink message 204 (such as a downlink PPDU, MU-PPDU, or a Trigger frame) including a user info field 206 associated with the STA 104. The user info field 206 may include one or more subfields that carry information indicative of an MCS, from a set of MCSs, associated with communication between the AP 102 and the STA 104. In some examples, the one or more subfields may collectively include at least five bits. In other words, the information indicative of the MCS may be associated with (may be or may be provided by) a set of at least five bits and may be contained within a single subfield or may be split across multiple subfields.

In some examples, the user info field 206 may be associated with a format 208-a according to which an MCS indication 210-a is split across multiple subfields. In other words, the AP 102 and the STA 104 may split the information indicative of the MCS across multiple subfields in accordance with the format 208-a. The multiple subfields may include a first subfield 212 and a second subfield 214. In some implementations, and in accordance with the signaling design associated with the format 208-a, the MCS indication 210-a may be split across two subfields of total at least five bits to separately indicate a code rate and a modulation scheme.

For example, the first subfield 212 may include at least two bits and may indicate a code rate from a set of available code rates. In such examples, the first subfield 212 may be referred to as a code rate subfield and the set of available code rates may include, for example, 1/2, 2/3, 3/4, and/or 5/6. Different permutations of the at least two bits may correspond to different code rates of the set of available code rates. For example, a first codepoint (such as 00) of the first subfield 212 may indicate a first code rate (such as 1/2), a second codepoint (such as 01) of the first subfield 212 may indicate a second code rate (such as 2/3), a third codepoint (such as 10) of the first subfield 212 may indicate a third code rate (such as 3/4), and a fourth codepoint (such as 11) of the first subfield 212 may indicate a fourth code rate (such as 5/6).

The second subfield 214 may include at least three bits and may indicate a modulation scheme from a set of modulation schemes. In such examples, the second subfield 214 may be referred to as a modulation subfield (or a modulation scheme subfield) and the set of available modulation schemes may include, for example, BPSK-DCM, BPSK, QPSK, 16QAM, 64QAM, 256QAM, 1024QAM, and/or 4096QAM. Different permutations of the at least three bits may correspond to different modulation schemes of the set of available modulation schemes. For example, a first codepoint (such as 000) of the second subfield 214 may indicate a first modulation scheme (such as BPSK-DCM), a second codepoint (such as 001) of the second subfield 214 may indicate a second modulation scheme (such as BPSK), a third code point (such as 011) of the second subfield 214 may indicate a third modulation scheme (such as QPSK), and so on.

In some aspects, a meaning, definition, or interpretation of the first subfield 212 (such as the code rate subfield) may change as a function of (or otherwise depend on or be in accordance with) the indicated modulation scheme. For example, codepoints for BPSK-DCM and BPSK-DCM in DUP mode may not be separately defined (such that there may only be a codepoint of the second subfield 214 that indicates BPSK) and, to indicate one of BPSK-DCM or BPSK-DCM in DUP mode, the AP 102 may set the second subfield 214 to be indicative of BPSK and may set the first subfield 212 to indicate a code rate not supported as a valid MCS for BPSK. In such an example, to indicate BPSK-DCM, the AP 102 may set the second subfield 214 to be indicative of BPSK and may set the first subfield 212 to be indicative of 3/4 to indicate MCS15 (1/2, BPSK-DCM). For further example, to indicate BPSK-DCM in DUP mode, the AP 102 may set the second subfield 214 to be indicative of BPSK and may set the first subfield 212 to be indicative of 5/6 to indicate MCS14 (1/2, BPSK-DCM in DUP mode). If a combination of (code rate, modulation scheme) indicated by the first subfield 212 and the second subfield 214 does not map to a valid MCS of the set of available MCSs, the AP 102 and the STA 104 may assume or expect (such as in accordance with a signaled or network specification-defined rule) that such a combination of (code rate, modulation scheme) actually maps to or is indicative of another MCS within the set of available MCSs.

For example, such a mechanism may be extended to enable a 2-bit code rate field and a 3-bit modulation scheme field to indicate code rates from a set of greater than four code rates. In such examples, the AP 102 may use a second subfield 214 to indicate 64QAM and a first subfield 212 to indicate a code rate not valid for 64QAM to indicate that a code rate of, for example, 7/8 is to be used for 64QAM. In other words, the AP 102 may indicate a code rate of 7/8 with specific modulation(s) by repurposing a code rate value for these modulation(s) to indicate 7/8.

In some other examples, the first subfield 212 may indicate a range of MCS indices within which an indicated MCS is located and the second subfield 214 may indicate the MCS with respect to the range of MCS indices. In such examples, the first subfield 212 may be a 1-bit field and may indicate that the indicated MCS is within a first range of MCSs indices or a second range of MCS indices. For example, a first value (such as a 0 value) of the first subfield 212 may indicate the first range of MCS indices (such as MCS indices 0-15) and a second value (such as a 1 value) of the first subfield 212 may indicate the second range of MCS indices (such as MCS indices 16-31). In some implementations, the second range of MCS indices may include both indices corresponding to valid MCSs and reserved values (which may be set as validate bits, such that the first subfield 212 and the second subfield 214 may be set to a validate state). The second subfield 214 may include at least four bits and indicate an MCS with respect to the indicated range, such that, for example, an indicated MCS index of three may correspond to MCS3 if the first range of MCS indices is indicated and may correspond to MCS19 if the second range of MCS indices is indicated. An example of such an extended set of available MCS indices including both a first range (such as 0-15) and a second range (such as 16-31) is illustrated in Table 3, shown below. In such examples, MCS0-15 may be the same as EHT MCS0-15.

TABLE 3
Extended Range of MCS Indices

| MCS | Code | | DUP |
|---|---|---|---|
| Index | Rate | Modulation | Mode |
| 0 | 1/2 | BPSK | No |
| 1 | 1/2 | QPSK | No |
| 2 | 3/4 | QPSK | No |
| 3 | 1/2 | 16 QAM | No |
| 4 | 3/4 | 16 QAM | No |
| 5 | 2/3 | 64 QAM | No |
| 6 | 3/4 | 64 QAM | No |
| 7 | 5/6 | 64 QAM | No |
| 8 | 3/4 | 256 QAM | No |
| 9 | 5/6 | 256 QAM | No |
| 10 | 3/4 | 1024 QAM | No |
| 11 | 5/6 | 1024 QAM | No |
| 12 | 3/4 | 4096 QAM | No |
| 13 | 5/6 | 4096 QAM | No |
| 14 | 1/2 | BPSK-DCM | Yes |
| 15 | 1/2 | BPSK-DCM | No |
| 16 | Reserved | | |
| 17 | 2/3 | QPSK | No |
| 18 | Reserved | | |
| 19 | 2/3 | 16 QAM | No |
| 20 | 5/6 | 16 QAM | No |
| 21-23 | Reserved | | |
| 24 | 2/3 | 256 QAM | No |

| | |
|---|---|
| 25-31 | Reserved |

In some other examples, the user info field 206 may be associated with a format 208-b according to which an MCS indication 210-b is included within a single subfield 216. In other words, the AP 102 and the STA 104 may include the information indicative of the MCS within the single subfield 216 in accordance with the format 208-b. The single subfield 216 may include at least five bits and, in some implementations, one bit of the single subfield 216 may indicate the range of MCS indices within which an indicated MCS is located and a remainder of the bits within the single subfield 216 may indicate the MCS with respect to the range of MCS indices. For example, a most significant bit (MSB) of the single subfield 216 may indicate whether the indicated MCS index is within the first range of MCS indices (such as 0-15) and the second range of MCS indices (such as 16-31) and the other at least four bits of the single subfield 216 may indicate an MCS from within that range of MCS indices. Such an indicated MCS may be associated with an MCS index of the set of MCS indices illustrated by Table 3, shown above. In some implementations, the second range of MCS indices may include both indices corresponding to valid MCSs and reserved values (which may be set as validate bits, such that the single subfield 216 may be set to a validate state).

Such signaling designs to indicate an MCS from a set of MCSs potentially greater than 16 may be applicable to both MU PPDU transmissions (for downlink transmission) and Trigger frames (for trigger-based (TB) PPDU uplink transmissions). For example, the AP 102 and the STA 104 may support such signaling via a user info field in a non-MU-MIMO allocation in a UHR MU PPDU for transmission to a single user across the entire PPDU or an (M) RU, via a user info field in an MU-MIMO allocation in a UHR MU PPDU for transmission to one user in MU-MIMO, and/or via a UHR variant user info field in a Trigger frame. A UHR MU PPDU may include one or more user info fields within a UHR-signal field (UHR-SIG) (within a preamble) of the UHR MU PPDU. For non-MU-MIMO, such signaling designs may involve using at least five bits (if not more) to accurately indicate an MCS from a set of available MCSs. For MU-MIMO, such signaling designs may use a relatively smaller 4-bit indication if the set of available MCSs for MU-MIMO includes no more than 16 MCSs (such as if one or two MCSs are added in MU-MIMO, such that an indication of MCS14 or MCS15 may be repurposed to indicate the one or two new MCSs, without expanding the MCS field(s) to five bits). In some examples, the set of available MCSs for non-MU-MIMO may be at least partially different (in quantity and/or type) from the set of available MCSs for MU-MIMO. A 4-bit MCS indication may be used in some MU-MIMO variant user info fields and a 5-bit MCS indication may be used in some non-MU-MIMO variant user info fields.

FIG. 3 shows an example signaling diagram 300 that supports signaling designs for (un) equal modulation indication. The signaling diagram 300 may implement or be implemented to realize aspects of the wireless communication network 100 or the signaling diagram 200. For example, the signaling diagram 300 illustrates communication between an AP 102 and a STA 104, which may be examples of corresponding devices as described with reference to FIGS. 1 and/or 2.

In some implementations, the AP 102 may transmit, to the STA 104 via a communication link 302, a downlink message 304 (such as a downlink PPDU, MU PPDU, or a Trigger frame) including a user info field 306 associated with the STA 104. The downlink message 304 may be an example of the downlink message 204 as illustrated by and described with reference to FIG. 2. Similarly, the user info field 306 may be an example of the user info field 206 as illustrated by and described with reference to FIG. 2. The user info field 306 may include one or more subfields that carry information (such as information transmitted via a frame or a PPDU including the one or more subfields of the user info field 306) indicative of a pattern of modulation schemes. Such a pattern of modulation schemes may correspond to an equal modulation pattern or an unequal modulation pattern with a common code rate. An equal modulation pattern may indicate that a same modulation is to be applied (such as used) across all spatial streams allocated to the STA 104. An unequal modulation pattern may indicate that at least partially differing modulations are to be applied (such as used) across all spatial streams allocated to the STA 104. For example, a first unequal modulation pattern may indicate a first modulation for a first spatial stream, a second modulation for a second spatial stream, and a third modulation for a third spatial stream. For further example, a second unequal modulation pattern may indicate a first modulation for a first spatial steam, the first modulation for a second spatial stream, and a second modulation for a third spatial stream.

In some examples, the user info field 306 may be associated with a format 308-a according to which the user info field 306 includes an Nss subfield 310 and an equal/unequal modulation pattern subfield 312. The equal/unequal modulation pattern subfield 312 may indicate the pattern of modulation schemes, such as either equal modulation or unequal modulation (including modulation, such as QAM, variation pattern). The equal/unequal modulation pattern subfield 312 may include at least two bits and may be equivalently referred to as a modulation pattern subfield. In some aspects, the AP 102 and/or the STA 104 may construct and/or interpret the equal/unequal modulation pattern subfield 312 according to (such as in accordance with) the Nss subfield 310, which may indicate a numerical quantity of spatial streams allocated to the STA 104. For example, for 2-4ss, the equal/unequal modulation pattern subfield 312 may indicate equal modulation or a specific unequal modulation (such as QAM) variation pattern. For further example, for 1ss and for 5-8ss, the AP 102 and the STA 104 may use one value (such as one codepoint) of the equal/unequal modulation pattern subfield 312 to indicate equal modulation and may use or interpret other values (such as other codepoints) as validate bits. In other words, the other values of the equal/unequal modulation pattern subfield 312 may indicate a validate state for the equal/unequal modulation pattern subfield 312. An example of a set of available unequal modulation variation patterns is illustrated by Table 4, below. In some examples, the Nss subfield 310 indicates an Nss value and the equal/unequal modulation pattern subfield 312 indicates an equal/unequal modulation pattern index.

TABLE 4
2-bit Equal/Unequal Modulation Pattern field (Interpreted according to the Nss subfield)

| | Equal/Unequal | |
|---|---|---|
| Nss | Modulation Pattern Index | Description |
| 0 | 0 | 1 spatial stream |
| 0 | 1-3 | Validate |
| 1 | 0 | 2 spatial streams, equal modulation |
| 1 | 1 | 2 spatial streams, unequal modulation pattern #1 |
| | | (QAM/QAM-1) |
| 1 | 2 | 2 spatial streams, unequal modulation pattern #2 |
| | | (QAM/QAM-2) |
| 1 | 3 | Validate |
| 2 | 0 | 3 spatial streams, equal modulation |
| 2 | 1 | 3 spatial streams, unequal modulation pattern #1 |
| | | (QAM/QAM/QAM-1) |
| 2 | 2 | 3 spatial streams, unequal modulation pattern #2 |
| | | (QAM/QAM/QAM-2) |
| 2 | 3 | 3 spatial streams, unequal modulation pattern #3 |
| | | (QAM/QAM-1/QAM-2) |
| 3 | 0 | 4 spatial streams, equal modulation |
| 3 | 1 | 4 spatial streams, unequal modulation pattern #1 |
| | | (QAM/QAM/QAM/QAM-1) |
| 3 | 2 | 4 spatial streams, unequal modulation pattern #2 |
| | | (QAM/QAM/QAM/QAM-2) |
| 3 | 3 | 4 spatial streams, unequal modulation pattern #3 |
| | | (QAM/QAM/QAM-1/QAM-2) |
| >=4 | 0 | (Nss + 1) spatial streams, equal modulation |
| >=4 | 1-3 | Validate |

In some other examples, the user info field 306 may be associated with a format 308-b according to which the user info field 306 includes an Nss and equal/unequal modulation pattern 314. In such examples, the AP 102 and the STA 104 may repurpose the 4-bit Nss subfield to jointly indicate Nss (such as a numerical quantity of spatial streams allocated to the STA 104) and a pattern of modulation schemes (such as equal modulation or unequal modulation, including QAM variation pattern). The Nss and equal/unequal modulation pattern 314 may include four bits and may be equivalently referred to as an Nss and equal/unequal equal/unequal modulation pattern. The Nss and equal/unequal modulation pattern 314 may indicate an index that corresponds to a specific quantity of spatial streams and a pattern of modulation schemes. An example of a set of indices (and corresponding quantities of spatial streams and modulation patterns) is illustrated by Table 5, shown below.

TABLE 5
4-bit Nss and Equal/Unequal Modulation Pattern field

| Nss and Equal/Unequal | |
|---|---|
| Modulation Pattern Index | Description |
| 0 | 1 spatial stream |
| 1 | 2 spatial streams, equal modulation |
| 2 | 2 spatial streams, unequal modulation pattern #1 |
| | (QAM/QAM-1) |
| 3 | 2 spatial streams, unequal modulation pattern #2 |
| | (QAM/QAM-2) |
| 4 | 3 spatial streams, equal modulation |
| 5 | 3 spatial streams, unequal modulation pattern #1 |
| | (QAM/QAM/QAM-1) |
| 6 | 3 spatial streams, unequal modulation pattern #2 |
| | (QAM/QAM/QAM-2) |
| 7 | 3 spatial streams, unequal modulation pattern #3 |
| | (QAM/QAM-1/QAM-2) |
| 8 | 4 spatial streams, equal modulation |
| 9 | 4 spatial streams, unequal modulation pattern #1 |
| | (QAM/QAM/QAM/QAM-1) |
| 10 | 4 spatial streams, unequal modulation pattern #2 |
| | (QAM/QAM/QAM/QAM-2) |
| 11 | 4 spatial streams, unequal modulation pattern #3 |
| | (QAM/QAM/QAM-1/QAM-2) |
| 12 | 5 spatial streams, equal modulation |
| 13 | 6 spatial streams, equal modulation |
| 14 | 7 spatial streams, equal modulation |
| 15 | 8 spatial streams, equal modulation |

Regardless of whether the pattern of modulation schemes is conveyed via the equal/unequal modulation pattern subfield 312 (a dedicated subfield) or jointly with Nss via the Nss and equal/unequal modulation pattern 314, the AP 102 and the STA 104 may assume or expect that the first spatial stream (or the last spatial stream, or any other anchor spatial stream) uses the MCS indicated in the MCS subfield(s), such as the subfield(s) illustrated by and described with reference to FIG. 2 or another MCS subfield (such as a 4-bit MCS subfield). In unequal QAM (an unequal modulation pattern), other streams (after the first, last, or other anchor stream) may use a respective QAM according to the unequal QAM pattern. For example, if the Nss and equal/unequal modulation pattern 314 indicates an index of five, the AP 102 and the STA 104 may use 3ss and may use a first QAM for a first spatial stream (such as the first, last, or anchor spatial stream), the same first QAM for a second spatial stream, and QAM-1 for a third spatial stream. In some examples, the first QAM may correspond to the modulation scheme associated with the MCS indicated by the user info field 306. QAM-1 may correspond to a modulation scheme associated with the next smallest index relative to the QAM associated with the MCS indicated by the user info field 306, QAM-2 may correspond to a modulation scheme associated with an index two indices lower than the QAM associated with the MCS indicated by the user info field 306, and so on.

To support such signaling designs to indicate a pattern of modulation schemes (with or without the MCS indication illustrated by and described with reference to FIG. 2), the AP 102 and the STA 104 may support associated signaling designs in the user info field format for a non-MU-MIMO allocation in a UHR MU PPDU, signaling designs in the user info field format for an MU-MIMO allocation in a UHR MU PPDU, and/or signaling designs in the UHR variant user info field design in a Trigger frame. In some aspects, factors that may influence such signaling designs may include that MCSs added to non-MU-MIMO allocations and MCSs added to MU-MIMO allocations may not be the same (as MU-MIMO may use fewer MCSs as compared to non-MU-MIMO). Other factors may include that, in a UHR MU PPDU, the user info field format for a non-MU-MIMO allocation and the user info field format for an MU-MIMO allocation may be expected to have a same size (such as both 22 bits, both 23 bits, both 24 bits, and so on). If the size of the user info field format for a non-MU-MIMO allocation is increased by a given quantity of bits, some wireless communication systems may expect that a same quantity of bits are repurposed from, for example, the Disregard field of a UHR-SIG common field to keep the UHR-SIG in two symbols (if transmitting UHR-SIG using MCS0) in a transmission to a single user. Further, other factors may include that, in a Trigger frame, the size of the UHR variant user info field (from B0 to B39) may not change.

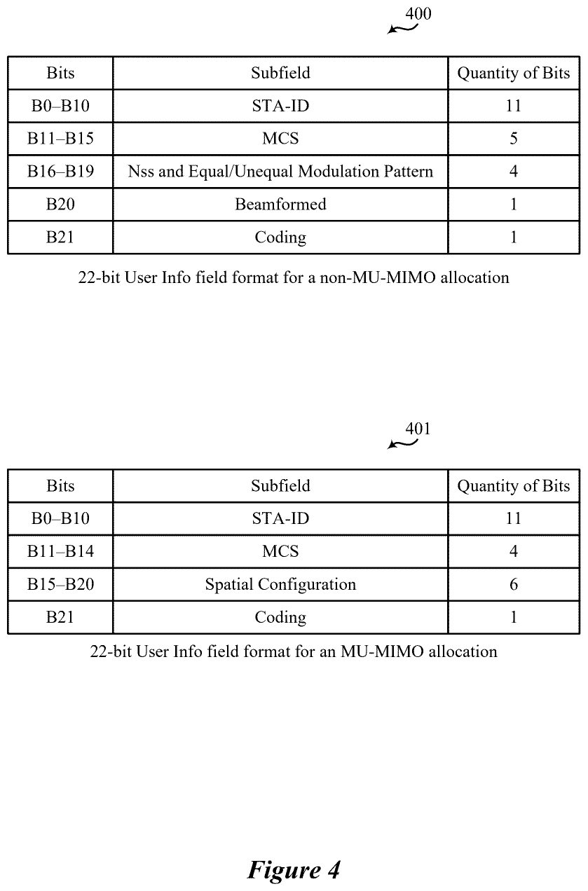

FIG. 4 shows example user info field formats 400 and 401 in an MU PPDU that support signaling designs for (un) equal modulation and/or MCS indication. The user info field formats 400 and 401 may implement or be implemented to realize one or more aspects of the wireless communication network 100, the signaling diagram 200, and/or the signaling diagram 300. For example, an AP 102 and a STA 104, which may be examples of corresponding devices as described with reference to FIGS. 1-3, may exchange (such as transmit and/or receive) signaling in accordance with one or both of the user info field formats 400 and 401. The user info field formats 400 and 401 may both be associated with a size of 22 bits, with the user info field format 400 illustrating a signaling design in the user info field format for a non-MU-MIMO allocation in a UHR MU PPDU and with the user info field format 401 illustrating a signaling design in the user info field format for an MU-MIMO allocation in a UHR MU PPDU. In accordance with the user info field formats 400 and 401, the AP 102 and the STA 104 may refrain from expecting any changes to the UHR-SIG common field.

In accordance with the user info field format 400, the AP 102 and the STA 104 may repurpose a 1-bit reserved field for one or more MCS subfields such that there are five bits available for MCS signaling (such as for MCS indication). For example, in accordance with the user info field format 400 being absent of a reserved field, the AP 102 and the STA 104 may use five of the 22 bits for MCS signaling. The AP 102 and the STA 104 may use such five bits in accordance with aspects disclosed herein, including by splitting such five bits across the first subfield 212 and the second subfield 214 or by including all of such five bits within the single subfield 216, as illustrated by and described with reference to FIG. 2. Additionally, or alternatively, the AP 102 and the STA 104 may repurpose a 4-bit Nss field to be an Nss and equal/unequal equal/unequal modulation pattern, which may be an example of the Nss and equal/unequal modulation pattern 314 as illustrated by and described with reference to FIG. 3.

In accordance with the user info field format 401, the AP 102 and the STA 104 may assume up to two new MCSs (in addition to the 14 MCSs available for MU-MIMO allocations) and may repurpose the MCS14 index and/or the MCS15 index to signal any one of the up to two new MCSs. In such implementations, the set of MCSs available for non-MU-MIMO allocations may be different than the set of MCSs available for MU-MIMO allocations. For example, the set of MCSs available for non-MU-MIMO allocations may include greater than 16 MCSs and the set of MCSs available for MU-MIMO allocations may include at most 16 MCSs.

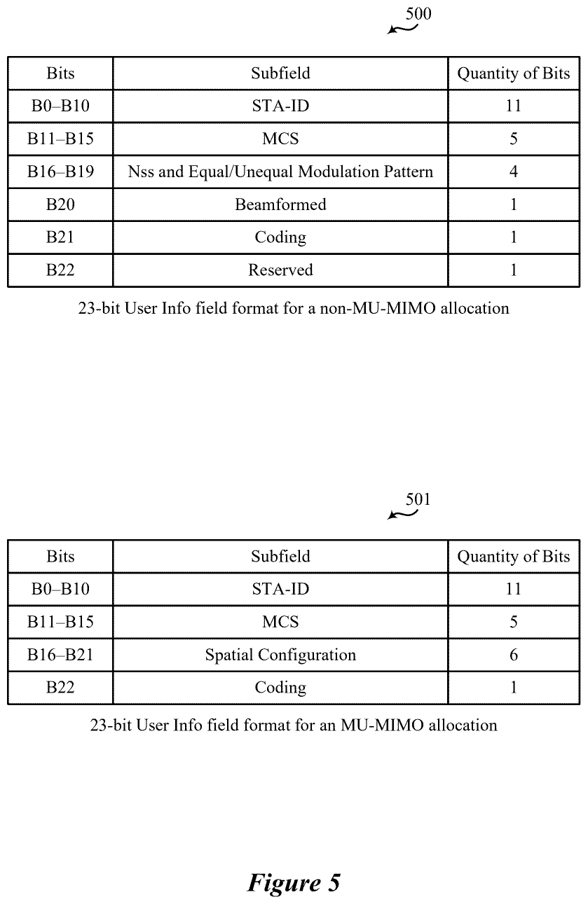

FIG. 5 shows example user info field formats 500 and 501 in an MU PPDU that support signaling designs for (un) equal modulation and/or MCS indication. The user info field formats 500 and 501 may implement or be implemented to realize one or more aspects of the wireless communication network 100, the signaling diagram 200, and/or the signaling diagram 300. For example, an AP 102 and a STA 104, which may be examples of corresponding devices as described with reference to FIGS. 1-3, may exchange (such as transmit and/or receive) signaling in accordance with one or both of the user info field formats 500 and 501. The user info field formats 500 and 501 may both be associated with a size of 23 bits, with the user info field format 500 illustrating a signaling design in the user info field format for a non-MU-MIMO allocation in a UHR MU PPDU and with the user info field format 501 illustrating a signaling design in the user info field format for an MU-MIMO allocation in a UHR MU PPDU. In accordance with the user info field formats 500 and 501, the AP 102 and the STA 104 may repurpose (such as drop, trim, or remove) 1 bit from the Disregard field to keep the UHR-SIG in two symbols if transmitting the UHR-SIG using (such as in) MCS0.

In accordance with the user info field format 500, the AP 102 and the STA 104 may expect or support an addition of 1 bit for the MCS field such that there are five bits available for MCS signaling (such as for MCS indication). For example, in accordance with the user info field format 500 including a reserved subfield of 1 bit and in accordance with the addition of 1 bit for MCS signaling, the AP 102 and the STA 104 may use five of the 23 bits for MCS signaling. The AP 102 and the STA 104 may use such five bits in accordance with aspects disclosed herein, including by splitting such five bits across the first subfield 212 and the second subfield 214 or by including all of such five bits within the single subfield 216, as illustrated by and described with reference to FIG. 2. Additionally, or alternatively, the AP 102 and the STA 104 may repurpose a 4-bit Nss field to be an Nss and equal/unequal modulation pattern subfield, which may be an example of the Nss and equal/unequal modulation pattern 314 as illustrated by and described with reference to FIG. 3.

In accordance with the user info field format 501, the AP 102 and the STA 104 may expect or support an addition of 1 bit for the MCS field such that there are five bits available for MCS signaling (such as for MCS indication). For example, in accordance with the user info field format 501 supporting the addition of 1 bit for MCS signaling, the AP 102 and the STA 104 may use five of the 23 bits for MCS signaling. The AP 102 and the STA 104 may use such five bits in accordance with aspects disclosed herein, including by splitting such five bits across the first subfield 212 and the second subfield 214 or by including all of such five bits within the single subfield 216, as illustrated by and described with reference to FIG. 2.

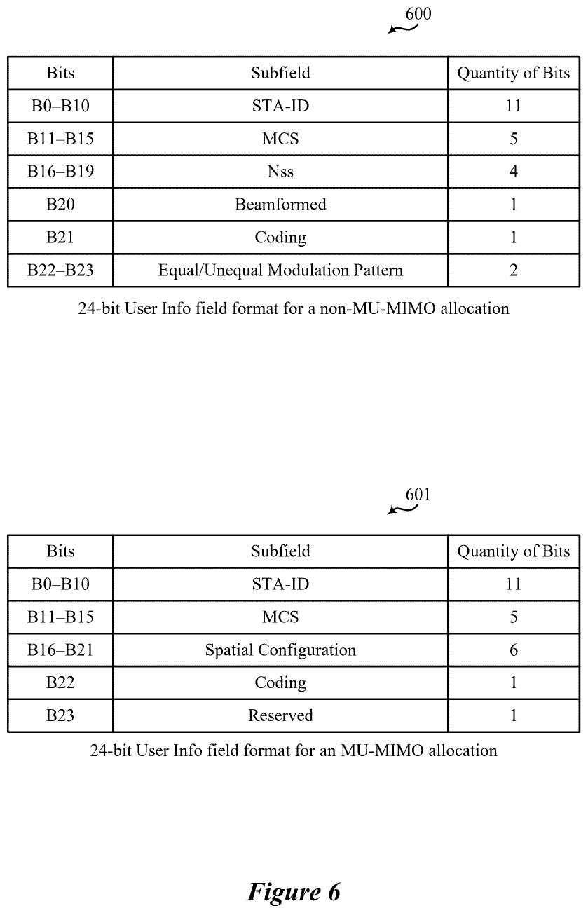

FIG. 6 shows example user info field formats 600 and 601 in an MU PPDU that support signaling designs for (un) equal modulation and/or MCS indication. The user info field formats 600 and 601 may implement or be implemented to realize one or more aspects of the wireless communication network 100, the signaling diagram 200, and/or the signaling diagram 300. For example, an AP 102 and a STA 104, which may be examples of corresponding devices as described with reference to FIGS. 1-3, may exchange (such as transmit and/or receive) signaling in accordance with one or both of the user info field formats 600 and 601. The user info field formats 600 and 601 may both be associated with a size of 24 bits, with the user info field format 600 illustrating a signaling design in the user info field format for a non-MU-MIMO allocation in a UHR MU PPDU and with the user info field format 601 illustrating a signaling design in the user info field format for an MU-MIMO allocation in a UHR MU PPDU. In accordance with the user info field formats 600 and 601, the AP 102 and the STA 104 may repurpose (such as drop, trim, or remove) 2 bits from the Disregard field to keep the UHR-SIG in two symbols if transmitting the UHR-SIG using (such as in) MCS0.

In accordance with the user info field format 600, the AP 102 and the STA 104 may repurpose a 1-bit reserved subfield for the MCS field such that there are five bits available for MCS signaling (such as for MCS indication). For example, in accordance with the user info field format 600 excluding a reserved subfield of 1 bit, the AP 102 and the STA 104 may use five of the 24 bits for MCS signaling. The AP 102 and the STA 104 may use such five bits in accordance with aspects disclosed herein, including by splitting such five bits across the first subfield 212 and the second subfield 214 or by including all of such five bits within the single subfield 216, as illustrated by and described with reference to FIG. 2. Additionally, or alternatively, in accordance with the user info field format 600, the AP 102 and the STA 104 may support an addition of a 2-bit equal/unequal modulation pattern subfield, which may be an example of the Nss and equal/unequal modulation pattern 314 as illustrated by and described with reference to FIG. 3.

In accordance with the user info field format 601, the AP 102 and the STA 104 may expect or support an addition of 1 bit for the MCS field such that there are five bits available for MCS signaling (such as for MCS indication). For example, in accordance with the user info field format 601 supporting the addition of 1 bit for MCS signaling, the AP 102 and the STA 104 may use five of the 24 bits for MCS signaling. The AP 102 and the STA 104 may use such five bits in accordance with aspects disclosed herein, including by splitting such five bits across the first subfield 212 and the second subfield 214 or by including all of such five bits within the single subfield 216, as illustrated by and described with reference to FIG. 2. In some implementations, in accordance with the user info field format 601, the AP 102 and the STA 104 may expect or support a 1-bit reserved subfield. In some aspects, such as 1-bit reserved subfield may align a size of the user info field format 601 with the size of the user info field format 600.

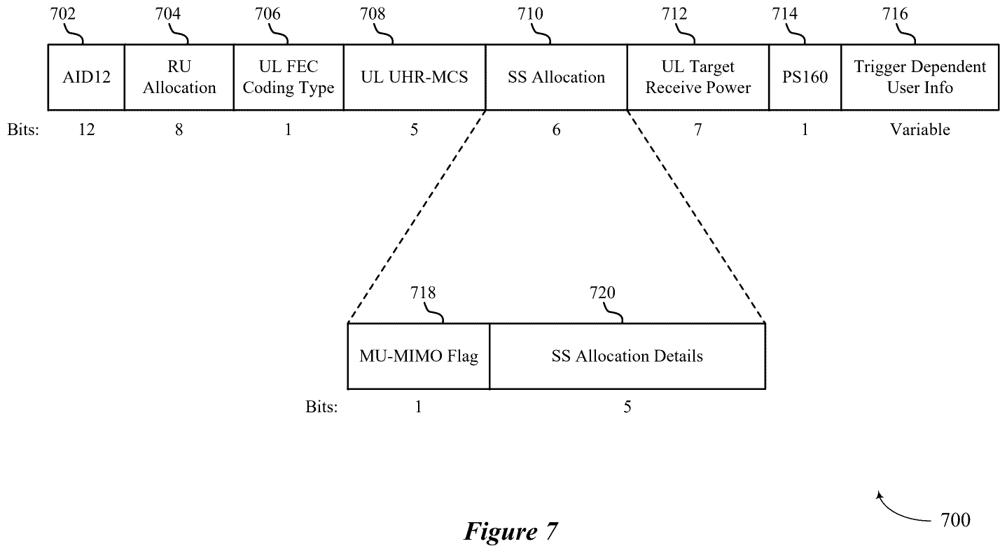

FIG. 7 shows an example user info field format 700 in a Trigger frame that supports signaling designs for (un) equal modulation and/or MCS indication. The user info field format 700 may implement or be implemented to realize one or more aspects of the wireless communication network 100, the signaling diagram 200, and/or the signaling diagram 300. For example, an AP 102 and a STA 104, which may be examples of corresponding devices as described with reference to FIGS. 1-3, may exchange (such as transmit and/or receive) signaling in accordance with the user info field format 700. In some implementations, the AP 102 may transmit, to the STA 104, a trigger frame in accordance with the user info field format 700 and the STA 104 may transmit an uplink PPDU in response to the trigger frame (such as in accordance with the trigger frame including a user info field associated with the STA 104 that complies with the user info field format 700).

The user info field format 700 in the Trigger frame may include an AID12 subfield 702, a resource unit (RU) allocation subfield 704, an uplink forward error correction (FEC) coding type subfield 706, an uplink UHR-MCS subfield 708 (which may include one or multiple subfields, such as in accordance with the user info field 206), a spatial stream (SS) allocation subfield 710, an uplink target receive power subfield 712, a PS160 subfield 714 (which may indicate a primary 160 MHz channel or a secondary 160 MHz channel that the RU or MRU allocation applies to if the size of the RU or the MRU is smaller than or equal to 2×996 tones; otherwise, the PS160 subfield 714 may be used to indicate the RU or MRU index along with the RU allocation subfield 704), and a trigger dependent user info subfield 716. Up to the trigger dependent user info subfield 716, the user info field format 700 may include 39 bits. In some systems, the SS allocation subfield 710 may lack an indication of a non-MU-MIMO allocation or an MU-MIMO allocation.

The user info field format 700 may be an example of a UHR variant user info field in a Trigger frame. To signal the UHR variant user info field, the AP 102 may set a PHY version identifier subfield in a special user info field to a specific value (such as a default or special value) to indicate UHR. Additionally, or alternatively, the AP 102 may set a value in the AID12 subfield 702 to be within a specific range, the specific range indicative of a UHR variant user info field.

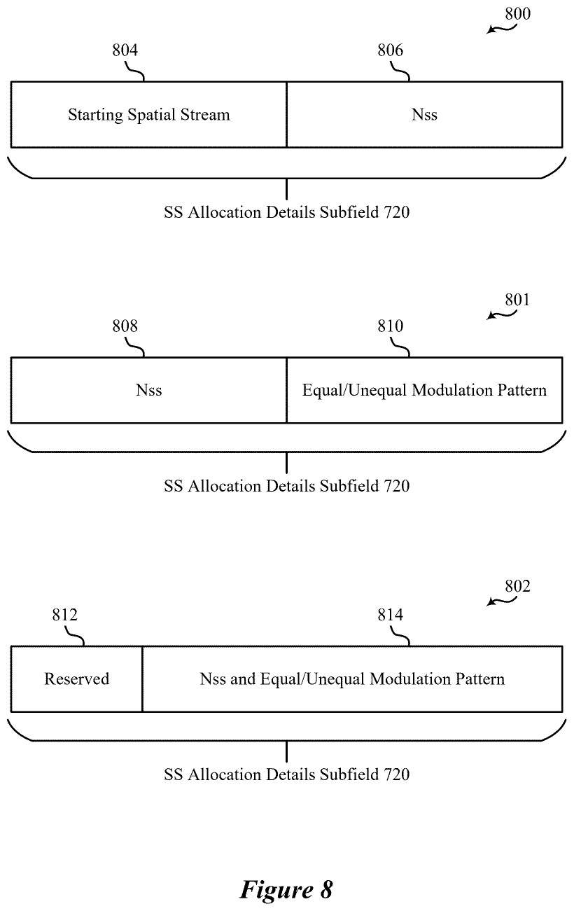

In accordance with the user info field format 700, the uplink UHR-MCS subfield 708 may include five bits. The AP 102 and the STA 104 may use such five bits in accordance with aspects disclosed herein, including by splitting such five bits across the first subfield 212 and the second subfield 214 or by including all of such five bits within the single subfield 216, as illustrated by and described with reference to FIG. 2. Additionally, or alternatively, and in accordance with the user info field format 700, the SS allocation subfield 710 may include an MU-MIMO flag subfield 718 (including, for example, 1 bit) and an SS allocation details subfield 720 (including, for example, five bits). In some examples, the AP 102 and/or the STA 104 may use and/or interpret the MU-MIMO flag subfield 718 as an indication of whether the allocation to the STA 104 is a non-MU-MIMO allocation (such as via a first bit value, such as a bit value of 0) or is an MU-MIMO allocation (such as via a second bit value, such as a bit value of 1). In some examples, the AP 102 and/or the STA 104 may use and/or interpret the remaining bits of the SS allocation subfield 710 in the SS allocation details subfield 720 according to the MU-MIMO flag subfield 718 (such as in accordance with whether the user info field is associated with a non-MU-MIMO allocation or an MU-MIMO allocation). Additional details relating to such a use and/or interpretation of the SS allocation details subfield 720 are illustrated by and described herein, including with reference to FIG. 8.

FIG. 8 shows example subfield formats 800, 801, and 802 that support signaling designs for (un) equal modulation indication. The subfield formats 800, 801, and 802 may implement or be implemented to realize one or more aspects of the wireless communication network 100, the signaling diagram 200, and/or the signaling diagram 300. For example, an AP 102 and a STA 104, which may be examples of corresponding devices as described with reference to FIGS. 1-3, may transmit and/or receive a Trigger frame including an SS allocation details subfield (such as the SS allocation details subfield 720 as illustrated by and described with reference to FIG. 7) and the SS allocation details subfield may be formatted in accordance with the subfield format 800, 801, or 802.

For example, and as illustrated by the subfield format 800, the SS allocation details subfield 720 may include a starting spatial stream subfield 804 and an Nss subfield 806. The starting spatial stream subfield 804 may indicate a spatial stream, from a set of spatial streams, starting from which spatial streams are allocated to the STA 104. The Nss subfield 806 may indicate the quantity of spatial streams allocated for the STA 104 from the starting spatial. In some examples, the AP 102 and/or the STA 104 may use and/or interpret the SS allocation details subfield 720 in accordance with the subfield format 800 if the MU-MIMO flag subfield 718 indicates an MU-MIMO allocation for the STA 104. In some implementations, the starting spatial stream subfield 804 may include three bits and the Nss subfield 806 may include two bits.

As illustrated by the subfield format 801, the SS allocation details subfield 720 may include an Nss subfield 808 and an equal/unequal modulation pattern subfield 810 (which may be an example of the equal/unequal modulation pattern subfield 312 as illustrated by and described with reference to FIG. 3). The Nss subfield 806 may indicate the quantity of spatial streams allocated for the STA 104 and the equal/unequal modulation pattern subfield 810 may indicate a pattern of modulation schemes associated with communication between the AP 102 and the STA 104. In other words, in accordance with the subfield format 801, the SS allocation details subfield 720 may separately indicate a quantity of spatial streams and a pattern of modulation schemes. In some examples, the AP 102 and/or the STA 104 may use and/or interpret the SS allocation details subfield 720 in accordance with the subfield format 801 if the MU-MIMO flag subfield 718 indicates a non-MU-MIMO allocation for the STA 104. In some implementations, the Nss subfield 808 may include three bits and the equal/unequal modulation pattern subfield 810 may include two bits.

As illustrated by the subfield format 802, the SS allocation details subfield 720 may include a reserved subfield 812 and an Nss and equal/unequal modulation pattern subfield 814. The Nss and equal/unequal modulation pattern subfield 814 may jointly indicate a quantity of spatial streams and a pattern of modulation schemes, such as via a single codepoint. In other words, the Nss and equal/unequal modulation pattern subfield 814 may combine an Nss indication and an equal/unequal modulation indication. The Nss and equal/unequal modulation pattern subfield 814 may be an example of the Nss and equal/unequal modulation pattern 314 as illustrated by and described with reference to FIG. 3. In some examples, the AP 102 and/or the STA 104 may use and/or interpret the SS allocation details subfield 720 in accordance with the subfield format 802 if the MU-MIMO flag subfield 718 indicates a non-MU-MIMO allocation for the STA 104. In some implementations, the reserved subfield 812 may include one bit and the Nss and equal/unequal modulation pattern subfield 814 may include four bits.

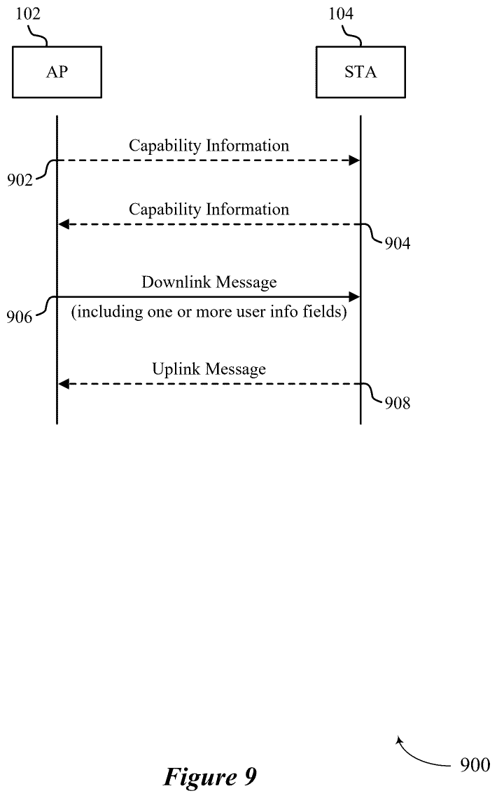

FIG. 9 shows an example process flow 900 that supports signaling designs for (un) equal modulation and/or MCS indication. The process flow 900 may implement or be implemented to realize one or more aspects of the wireless communication network 100; the signaling diagrams 200 and/or 300; the user info field formats 400, 401, 500, 501, 600, and/or 601 in MU PPDUs; the user info field format 700 in a Trigger frame; and/or the subfield formats 800, 801, and/or 802. For example, the process flow 900 illustrates communication between an AP 102 and a STA 104, which may be examples of corresponding devices described herein, including with reference to FIGS. 1-8. In some implementations, the AP 102 may transmit downlink signaling to the STA 104 including one or more user info fields associated with any one or more of the user info field formats disclosed herein and the AP 102 and the STA 104 may communicate in accordance with the information conveyed via the one or more user info fields.

In the following description of process flow 900, the operations between the AP 102 and the STA 104 may be performed in a different order than the order shown, or other operations may be added or removed from the process flow 900. For example, some operations may also be left out of process flow 900, or may be performed in different orders or at different times. Further, although some operations or signaling may be shown to occur at different times for discussion purposes, these operations may actually occur at the same time. Although the AP 102 and the STA 104 are shown performing the operations of process flow 900, some aspects of some operations may also be performed by one or more other wireless communication devices.

At 902, the AP 102 may transmit, to the STA 104, capability information. Similarly, at 904, the STA 104 may transmit, to the AP 102, capability information. Such a communication (such as an exchange, such as transmission and/or reception) of capability information may be associated with conveying that the AP 102 and the STA 104 are capable of supporting MCSs in addition to MCS0-15 (such as capable of supporting UHR MCSs) and/or that the AP 102 and the STA 104 are capable of supporting patterns of modulation schemes. For example, the AP 102 may indicate that the AP 102 has UHR capabilities and/or the STA 104 may indicate that the STA 104 has UHR capabilities.

The AP 102 may generate or configure communication to the STA 104 in accordance with the capability of the STA 104. For example, if the STA 104 indicates, via its capability information, that the STA 104 is not capable of supporting MCSs in addition to MCS0-15 and/or not capable of supporting patterns of modulation schemes, the AP 102 may generate or configure user info fields associated with the STA 104 to avoid indicating an MCS outside of MCS0-15 and/or to avoid indicating a pattern of modulation schemes. Alternatively, if the STA 104 indicates, via its capability information, that the STA 104 is capable of supporting MCSs in addition to MCS0-15 and/or is capable of supporting patterns of modulation schemes, the AP 102 may generate or configure user info fields associated with the STA 104 to indicate an MCS outside of MCS0-15 and/or to indicate a pattern of modulation schemes, or may otherwise format such user info fields in accordance with the capability of the STA 104.

At 906, the AP 102 may transmit a downlink message (such as a downlink PPDU, an MU PPDU, or a Trigger frame) including one or more user info fields. The one or more user info fields may include a user info field associated with the STA 104 (among potentially other user info fields associated with potentially other STAs 104). In some implementations, the AP 102 may indicate, provide, or convey, via one or more subfields of the user info field, information indicative of an MCS, from a set of MCSs, associated with communication between the AP 102 and the STA 104. In such implementations, the one or more subfields may collectively include at least five bits. Additional details relating to such one or more MCS subfields including at least five bits are illustrated and described herein, including by and with reference to FIGS. 2 and 4-7. Additionally, or alternatively, the AP 102 may indicate, provide, or convey, via the user info field, information indicative of a pattern of modulation schemes associated with the communication between the AP 102 and the STA 104. Additional details relating to such an indication of a pattern of modulation schemes are illustrated and described herein, including by and with reference to FIGS. 3-8.

The AP 102 and the STA 104 may communicate in accordance with the MCS and/or the pattern of modulation schemes. In some implementations, such communication may include reception, by the STA 104, of a remainder (or at least a portion of the remainder) of a downlink (MU) PPDU including the user info field. In some other implementations, such communication may include transmission, at 908, of an uplink message from the STA 104 to the AP 102. Such an uplink message may be an example of an uplink PPDU, such as an uplink TB PPDU (which may be sent responsive to a Trigger frame including the user info field). In any implementation, the communication may include (de) modulation and/or encoding/decoding, by the AP 102 and/or the STA 104, of data in accordance with the MSC and/or the pattern of modulation schemes.

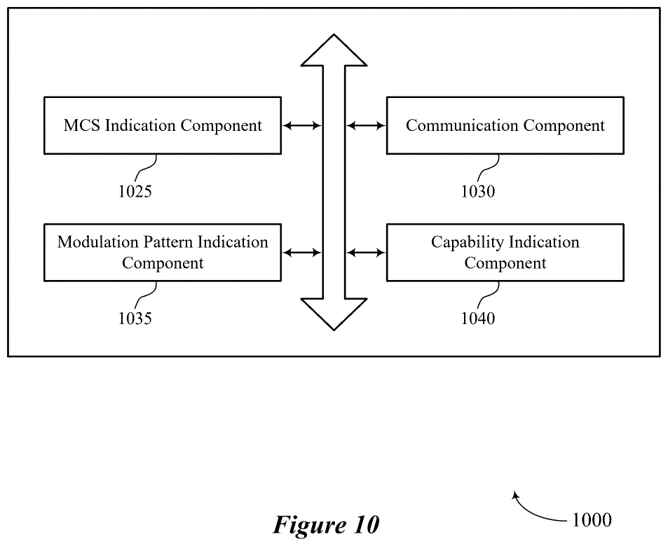

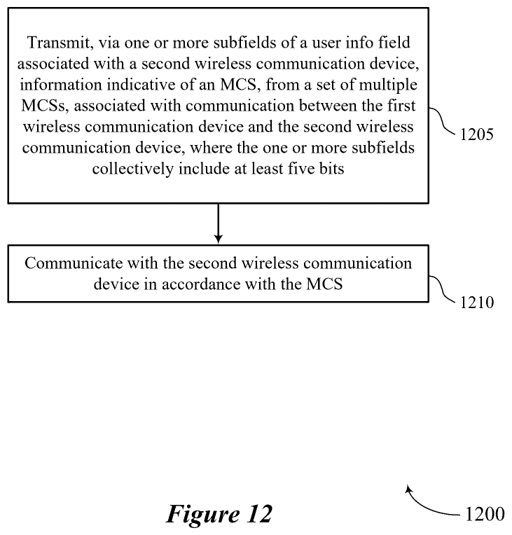

FIG. 10 shows a block diagram of an example wireless communication device 1000 that supports signaling designs for (un) equal modulation and/or MCS indication. In some examples, the wireless communication device 1000 is configured to perform the processes 1200, 1300, 1400, 1500, 1600, and 1700 described with reference to FIGS. 12, 13, 14, 15, 16, and 17, respectively. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when (such as in accordance with being) executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communication in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communication conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes an MCS indication component 1025, a communication component 1030, a modulation pattern indication component 1035, and a capability indication component 1040. Portions of one or more of the MCS indication component 1025, the communication component 1030, the modulation pattern indication component 1035, and the capability indication component 1040 may be implemented at least in part in hardware or firmware. For example, one or more of the MCS indication component 1025, the communication component 1030, the modulation pattern indication component 1035, and the capability indication component 1040 may be implemented at least in part by at least a processor or a modem. In some examples, portions of one or more of the MCS indication component 1025, the communication component 1030, the modulation pattern indication component 1035, and the capability indication component 1040 may be implemented at least in part by a processor and software in the form of processor-executable code stored in memory.

The wireless communication device 1000 may support wireless communication in accordance with examples as disclosed herein. The MCS indication component 1025 is configurable or configured to transmit, via one or more subfields of a user info field associated with a second wireless communication device, information indicative of an MCS, from a set of multiple MCSs, associated with communication between the first wireless communication device and the second wireless communication device. In some examples, the one or more subfields collectively include at least five bits. The communication component 1030 is configurable or configured to communicate with the second wireless communication device in accordance with the MCS.

In some examples, a first subset of the at least five bits is indicative of a code rate associated with the MCS and a second subset of the at least five bits is indicative of a modulation associated with the MCS.

In some examples, the one or more subfields include a first subfield and a second subfield. In some examples, the first subfield includes the first subset of the at least five bits and the second subfield includes the second subset of the at least five bits.

In some examples, the first subfield includes two bits and the second subfield includes three bits.

In some examples, a first subset of the at least five bits is indicative of a range of MCS indices within which an index corresponding to the MCS is located and a second subset of the at least five bits is indicative of the MCS with respect to the range of MCS indices. In some examples, the range of MCS indices corresponds to a subset of the set of multiple MCSs.

In some examples, the one or more subfields consists of a single subfield. In some examples, the single subfield includes the first subset of the at least five bits and the second subset of the at least five bits.

In some examples, the one or more subfields include a first subfield and a second subfield. In some examples, the first subfield includes the first subset of the at least five bits and the second subfield includes the second subset of the at least five bits.

In some examples, the first subset of the at least five bits includes one bit and the second subset of the at least five bits includes four bits.

In some examples, the user info field includes second information indicative of a pattern of modulation schemes associated with the communication between the first wireless communication device and the second wireless communication device. In some examples, the pattern of modulation schemes corresponds to an equal modulation pattern including same types of modulation across a set of multiple spatial streams or an unequal modulation pattern including different types of modulation across the set of multiple spatial streams with a common code rate. In some examples, communicating with the second wireless communication device is further in accordance with the pattern of modulation schemes.

In some examples, the MCS indicated by the user info field is an anchor MCS associated with the pattern of modulation schemes.

In some examples, the second information includes a quantity of the set of multiple spatial streams and the pattern of modulation schemes. In some examples, the user info field includes a subfield that jointly indicates the quantity of the set of multiple spatial streams and the pattern of modulation schemes.

In some examples, the user info field is absent of a reserved subfield in accordance with the user info field including the one or more subfields that collectively include the at least five bits and including the subfield that jointly indicates the quantity of the set of multiple spatial streams and the pattern of modulation schemes.

In some examples, the user info field includes at least 22 bits.

In some examples, the user info field includes a reserved subfield in accordance with the user info field including the one or more subfields that collectively include the at least five bits and including the subfield that jointly indicates the quantity of the set of multiple spatial streams and the pattern of modulation schemes.

In some examples, the user info field includes at least 23 bits.

In some examples, the second information includes a quantity of the set of multiple spatial streams and the pattern of modulation schemes. In some examples, the user info field includes a first subfield that indicates the quantity of the set of multiple spatial streams and a second subfield that indicates the pattern of modulation schemes.

In some examples, the user info field is absent of a reserved subfield in accordance with the user info field including the one or more subfields that collectively include the at least five bits, including the first subfield that indicates the quantity of the set of multiple spatial streams, and including the second subfield that indicates the pattern of modulation schemes.

In some examples, the user info field includes at least 24 bits.

In some examples, the user info field is associated with a non-MU-MIMO resource allocation and is included within an MU PPDU.

In some examples, the user info field includes a spatial stream allocation subfield that includes a set of multiple bits. In some examples, the set of multiple bits includes a first subset of bits and a second subset of bits. In some examples, the first subset of bits provides an indication of whether the user info field is associated with a non-MU-MIMO resource allocation or an MU-MIMO resource allocation.

In some examples, the second subset of bits is interpreted in accordance with whether the user info field is associated with the non-MU-MIMO resource allocation or the MU-MIMO resource allocation.

In some examples, the first subset of bits indicates that the user info field is associated with the MU-MIMO resource allocation. In some examples, the second subset of bits indicates a starting spatial stream and a quantity of a set of multiple spatial streams associated with the communication between the first wireless communication device and the second wireless communication device.

In some examples, the first subset of bits indicates that the user info field is associated with the non-MU-MIMO resource allocation. In some examples, the second subset of bits indicates a quantity of a set of multiple spatial streams and a pattern of modulation schemes associated with the communication between the first wireless communication device and the second wireless communication device. In some examples, the pattern of modulation schemes corresponds to an equal modulation including same types of modulation pattern across the set of multiple spatial streams or an unequal modulation pattern including different types of modulation across the set of multiple spatial streams with a common code rate.

In some examples, the second subset of bits separately indicates the quantity of the set of multiple spatial streams and the pattern of modulation schemes. In some examples, the second subset of bits jointly indicates the quantity of the set of multiple spatial streams and the pattern of modulation schemes.

In some examples, the user info field is included within a trigger frame.

In some examples, the MCS indication component 1025 is configurable or configured to transmit a first frame that includes the user info field associated with the second wireless communication device. In some examples, the user info field is associated with a non-MU-MIMO resource allocation. In some examples, the set of multiple MCSs are associated with the non-MU-MIMO resource allocation. In some examples, the MCS indication component 1025 is configurable or configured to transmit, via a second user info field of the first frame or a second frame, second information indicative of a second MCS, from a second set of multiple MCSs, associated with second communication between the first wireless communication device and at least a third wireless communication device. In some examples, the second user info field is associated with an MU-MIMO resource allocation. In some examples, the second set of multiple MCSs are associated with the MU-MIMO resource allocation.

In some examples, an MCS subfield of the second user info field provides the second information via four bits. In some examples, the second user info field includes 22 bits.

In some examples, the second set of multiple MCSs is different than the set of multiple MCSs. In some examples, the second set of multiple MCSs includes at most 16 MCSs and the set of multiple MCSs includes greater than 16 MCSs.

In some examples, the capability indication component 1040 is configurable or configured to communicate capability information with the second wireless communication device. In some examples, transmitting the information indicative of the MCS via the one or more subfields that collectively include the at least five bits is in accordance with the capability information.

Additionally, or alternatively, the wireless communication device 1000 may support wireless communication in accordance with examples as disclosed herein. The modulation pattern indication component 1035 is configurable or configured to transmit, via a user info field associated with a second wireless communication device, information indicative of a pattern of modulation schemes associated with communication between the first wireless communication device and the second wireless communication device. In some examples, the pattern of modulation schemes corresponds to an equal modulation pattern including same types of modulation across a set of multiple spatial streams or an unequal modulation pattern including different types of modulation across the set of multiple spatial streams with a common code rate. In some examples, the communication component 1030 is configurable or configured to communicate with the second wireless communication device in accordance with the pattern of modulation schemes.

In some examples, the user info field includes a first subfield that indicates a quantity of the set of multiple spatial streams and a second subfield that indicates the pattern of modulation schemes.

In some examples, the second subfield is interpreted in accordance with the quantity of the set of multiple spatial streams.

In some examples, the second subfield includes a set of bits. In some examples, for a quantity of spatial streams, each respective permutation of the set of bits indicates a respective pattern of modulation schemes across the quantity of spatial streams or a validate state for the second subfield.

In some examples, a permutation of the set of bits indicates one of the equal modulation pattern or a specific unequal modulation pattern in accordance with the quantity of spatial streams being two, three, or four.

In some examples, a permutation of the set of bits indicates one of the equal modulation pattern or the validate state for the second subfield in accordance with the quantity of spatial streams being one or greater than four.

In some examples, the set of bits includes two bits.

In some examples, the user info field includes a subfield that jointly indicates a quantity of the set of multiple spatial streams and the pattern of modulation schemes.

In some examples, the subfield includes a set of bits. In some examples, each respective permutation of the set of bits indicates a respective quantity of the set of multiple spatial streams and a respective pattern of modulation schemes across the set of multiple spatial streams.

In some examples, the set of bits includes four bits.

In some examples, the user info field includes one or more subfields that include second information indicative of an MCS, from a set of multiple MCSs, associated with the communication between the first wireless communication device and the second wireless communication device. In some examples, communicating with the second wireless communication device is further in accordance with the MCS.

In some examples, the MCS indicated by the user info field is an anchor MCS associated with the pattern of modulation schemes.

In some examples, the one or more subfields collectively include at least five bits.

In some examples, the user info field is absent of a reserved subfield in accordance with the user info field including the one or more subfields that collectively include the at least five bits and including a subfield that jointly indicates a quantity of the set of multiple spatial streams and the pattern of modulation schemes.

In some examples, the user info field includes at least 22 bits.

In some examples, the user info field includes a reserved subfield in accordance with the user info field including the one or more subfields that collectively include the at least five bits and including a subfield that jointly indicates a quantity of the set of multiple spatial streams and the pattern of modulation schemes.

In some examples, the user info field includes at least 23 bits.

In some examples, the user info field is absent of a reserved subfield in accordance with the user info field including the one or more subfields that collectively include the at least five bits, including a first subfield that indicates a quantity of the set of multiple spatial streams, and including a second subfield that indicates the pattern of modulation schemes.

In some examples, the user info field includes at least 24 bits.

In some examples, the user info field includes a spatial stream allocation subfield that includes a set of multiple bits. In some examples, the set of multiple bits includes a first subset of bits and a second subset of bits. In some examples, the first subset of bits provides an indication of whether the user info field is associated with a non-MU-MIMO resource allocation or an MU-MIMO resource allocation.

In some examples, the second subset of bits is interpreted in accordance with whether the user info field is associated with the non-MU-MIMO resource allocation or the MU-MIMO resource allocation.

In some examples, the first subset of bits indicates that the user info field is associated with the non-MU-MIMO resource allocation. In some examples, the second subset of bits indicates a quantity of the set of multiple spatial streams and the pattern of modulation schemes associated with the communication between the first wireless communication device and the second wireless communication device.

In some examples, the second subset of bits separately indicates the quantity of the set of multiple spatial streams and the pattern of modulation schemes. In some examples, the second subset of bits jointly indicates the quantity of the set of multiple spatial streams and the pattern of modulation schemes.

In some examples, the user info field is included within a trigger frame.

In some examples, the user info field is associated with a non-MU-MIMO resource allocation and is included within an MU PPDU.

In some examples, the capability indication component 1040 is configurable or configured to communicate capability information with the second wireless communication device. In some examples, transmitting the information indicative of the pattern of modulation schemes via the user info field is in accordance with the capability information.

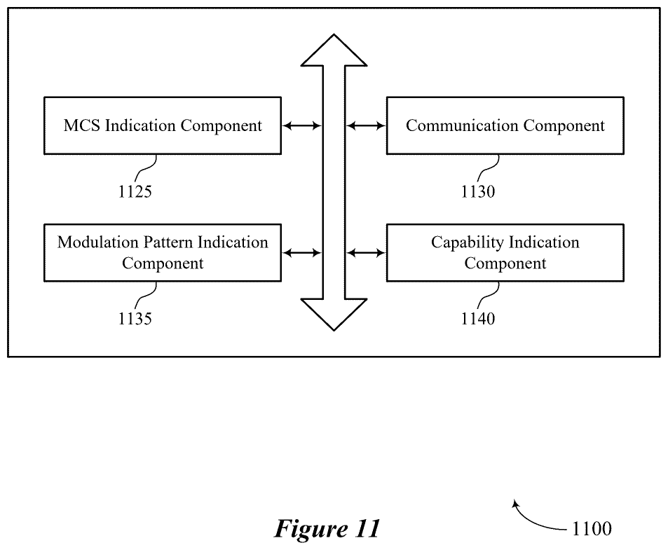

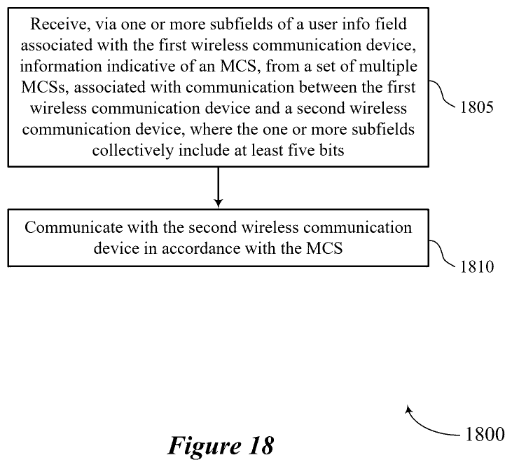

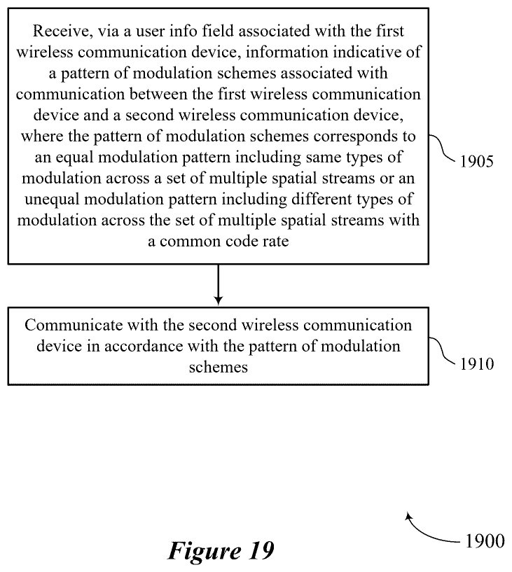

FIG. 11 shows a block diagram of an example wireless communication device 1100 that supports signaling designs for (un) equal modulation and/or MCS indication. In some examples, the wireless communication device 1100 is configured to perform the processes 1800 and 1900 described with reference to FIGS. 18 and 19, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when (such as in accordance with being) executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in a STA, such as the STA 104 described with reference to FIG. 1. In some other examples, the wireless communication device 1100 can be a STA that includes such a processing system and other components including multiple antennas. The wireless communication device 1100 is capable of transmitting and receiving wireless communication in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communication conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes a user interface (UI) (such as a touchscreen or keypad) and a display, which may be integrated with the UI to form a touchscreen display that is coupled with the processing system. In some examples, the wireless communication device 1100 may further include one or more sensors such as, for example, one or more inertial sensors, accelerometers, temperature sensors, pressure sensors, or altitude sensors, that are coupled with the processing system.

The wireless communication device 1100 includes an MCS indication component 1125, a communication component 1130, a modulation pattern indication component 1135, and a capability indication component 1140. Portions of one or more of the MCS indication component 1125, the communication component 1130, the modulation pattern indication component 1135, and the capability indication component 1140 may be implemented at least in part in hardware or firmware. For example, one or more of the MCS indication component 1125, the communication component 1130, the modulation pattern indication component 1135, and the capability indication component 1140 may be implemented at least in part by at least a processor or a modem. In some examples, portions of one or more of the MCS indication component 1125, the communication component 1130, the modulation pattern indication component 1135, and the capability indication component 1140 may be implemented at least in part by a processor and software in the form of processor-executable code stored in memory.

The wireless communication device 1100 may support wireless communication in accordance with examples as disclosed herein. The MCS indication component 1125 is configurable or configured to receive, via one or more subfields of a user info field associated with the first wireless communication device, information indicative of an MCS, from a set of multiple MCSs, associated with communication between the first wireless communication device and a second wireless communication device. In some examples, the one or more subfields collectively include at least five bits. The communication component 1130 is configurable or configured to communicate with the second wireless communication device in accordance with the MCS.

In some examples, a first subset of the at least five bits is indicative of a code rate associated with the MCS and a second subset of the at least five bits is indicative of a modulation associated with the MCS.

In some examples, the one or more subfields include a first subfield and a second subfield. In some examples, the first subfield includes the first subset of the at least five bits and the second subfield includes the second subset of the at least five bits.

In some examples, the first subfield includes two bits and the second subfield includes three bits.

In some examples, a first subset of the at least five bits is indicative of a range of MCS indices within which an index corresponding to the MCS is located and a second subset of the at least five bits is indicative of the MCS with respect to the range of MCS indices. In some examples, the range of MCS indices corresponds to a subset of the set of multiple MCSs.

In some examples, the one or more subfields consists of a single subfield. In some examples, the single subfield includes the first subset of the at least five bits and the second subset of the at least five bits.

In some examples, the one or more subfields include a first subfield and a second subfield. In some examples, the first subfield includes the first subset of the at least five bits and the second subfield includes the second subset of the at least five bits.

In some examples, the first subset of the at least five bits includes one bit and the second subset of the at least five bits includes four bits.

In some examples, the user info field includes second information indicative of a pattern of modulation schemes associated with the communication between the first wireless communication device and the second wireless communication device. In some examples, the pattern of modulation schemes corresponds to an equal modulation pattern including same types of modulation across a set of multiple spatial streams or an unequal modulation pattern including different types of modulation across the set of multiple spatial streams with a common code rate. In some examples, communicating with the second wireless communication device is further in accordance with the pattern of modulation schemes.

In some examples, the MCS indicated by the user info field is an anchor MCS associated with the pattern of modulation schemes.

In some examples, the second information includes a quantity of the set of multiple spatial streams and the pattern of modulation schemes. In some examples, the user info field includes a subfield that jointly indicates the quantity of the set of multiple spatial streams and the pattern of modulation schemes.

In some examples, the user info field is absent of a reserved subfield in accordance with the user info field including the one or more subfields that collectively include the at least five bits and including the subfield that jointly indicates the quantity of the set of multiple spatial streams and the pattern of modulation schemes.

In some examples, the user info field includes at least 22 bits.

In some examples, the user info field includes a reserved subfield in accordance with the user info field including the one or more subfields that collectively include the at least five bits and including the subfield that jointly indicates the quantity of the set of multiple spatial streams and the pattern of modulation schemes.

In some examples, the user info field includes at least 23 bits.

In some examples, the second information includes a quantity of the set of multiple spatial streams and the pattern of modulation schemes. In some examples, the user info field includes a first subfield that indicates the quantity of the set of multiple spatial streams and a second subfield that indicates the pattern of modulation schemes.

In some examples, the user info field is absent of a reserved subfield in accordance with the user info field including the one or more subfields that collectively include the at least five bits, including the first subfield that indicates the quantity of the set of multiple spatial streams, and including the second subfield that indicates the pattern of modulation schemes.

In some examples, the user info field includes at least 24 bits.

In some examples, the user info field is associated with a non-MU-MIMO resource allocation and is included within an MU PPDU.

In some examples, the user info field includes a spatial stream allocation subfield that includes a set of multiple bits. In some examples, the set of multiple bits includes a first subset of bits and a second subset of bits. In some examples, the first subset of bits provides an indication of whether the user info field is associated with a non-MU-MIMO resource allocation or an MU-MIMO resource allocation.

In some examples, the second subset of bits is interpreted in accordance with whether the user info field is associated with the non-MU-MIMO resource allocation or the MU-MIMO resource allocation.

In some examples, the first subset of bits indicates that the user info field is associated with the MU-MIMO resource allocation. In some examples, the second subset of bits indicates a starting spatial stream and a quantity of a set of multiple spatial streams associated with the communication between the first wireless communication device and the second wireless communication device.

In some examples, the first subset of bits indicates that the user info field is associated with the non-MU-MIMO resource allocation. In some examples, the second subset of bits indicates a quantity of a set of multiple spatial streams and a pattern of modulation schemes associated with the communication between the first wireless communication device and the second wireless communication device. In some examples, the pattern of modulation schemes corresponds to an equal modulation pattern including same types of modulation across the set of multiple spatial streams or an unequal modulation pattern including different types of modulation across the set of multiple spatial streams with a common code rate.

In some examples, the second subset of bits separately indicates the quantity of the set of multiple spatial streams and the pattern of modulation schemes. In some examples, the second subset of bits jointly indicates the quantity of the set of multiple spatial streams and the pattern of modulation schemes.

In some examples, the user info field is included within a trigger frame.

In some examples, the MCS indication component 1125 is configurable or configured to receive a first frame that includes the user info field associated with the first wireless communication device. In some examples, the user info field is associated with a non-MU-MIMO resource allocation. In some examples, the set of multiple MCSs are associated with the non-MU-MIMO resource allocation. In some examples, the MCS indication component 1125 is configurable or configured to receive, via a second user info field of the first frame or a second frame, second information indicative of a second MCS, from a second set of multiple MCSs, associated with second communication between at least the first wireless communication device and the second wireless communication device. In some examples, the second user info field is associated with an MU-MIMO resource allocation. In some examples, the second set of multiple MCSs are associated with the MU-MIMO resource allocation.

In some examples, an MCS subfield of the second user info field provides the second information via four bits. In some examples, the second user info field includes 22 bits.

In some examples, the second set of multiple MCSs is different than the set of multiple MCSs. In some examples, the second set of multiple MCSs includes at most 16 MCSs and the set of multiple MCSs includes greater than 16 MCSs.

In some examples, the capability indication component 1140 is configurable or configured to communicate capability information with the second wireless communication device. In some examples, receiving the information indicative of the MCS via the one or more subfields that collectively include the at least five bits is in accordance with the capability information.

Additionally, or alternatively, the wireless communication device 1100 may support wireless communication in accordance with examples as disclosed herein. The modulation pattern indication component 1135 is configurable or configured to receive, via a user info field associated with the first wireless communication device, information indicative of a pattern of modulation schemes associated with communication between the first wireless communication device and a second wireless communication device. In some examples, the pattern of modulation schemes corresponds to an equal modulation pattern including same types of modulation across a set of multiple spatial streams or an unequal modulation pattern including different types of modulation across the set of multiple spatial streams with a common code rate. In some examples, the communication component 1130 is configurable or configured to communicate with the second wireless communication device in accordance with the pattern of modulation schemes.

In some examples, the user info field includes a first subfield that indicates a quantity of the set of multiple spatial streams and a second subfield that indicates the pattern of modulation schemes.

In some examples, the second subfield is interpreted in accordance with the quantity of the set of multiple spatial streams.

In some examples, the second subfield includes a set of bits. In some examples, for a quantity of spatial streams, each respective permutation of the set of bits indicates a respective pattern of modulation schemes across the quantity of spatial streams or a validate state for the second subfield.

In some examples, a permutation of the set of bits indicates one of the equal modulation pattern or a specific unequal modulation pattern in accordance with the quantity of spatial streams being two, three, or four.

In some examples, a permutation of the set of bits indicates one of the equal modulation pattern or the validate state for the second subfield in accordance with the quantity of spatial streams being one or greater than four.

In some examples, the set of bits includes two bits.

In some examples, the user info field includes a subfield that jointly indicates a quantity of the set of multiple spatial streams and the pattern of modulation schemes.

In some examples, the subfield includes a set of bits. In some examples, each respective permutation of the set of bits indicates a respective quantity of the set of multiple spatial streams and a respective pattern of modulation schemes across the set of multiple spatial streams.

In some examples, the set of bits includes four bits.

In some examples, the user info field includes one or more subfields that include second information indicative of an MCS, from a set of multiple MCSs, associated with the communication between the first wireless communication device and the second wireless communication device. In some examples, communicating with the second wireless communication device is further in accordance with the MCS.

In some examples, the MCS indicated by the user info field is an anchor MCS associated with the pattern of modulation schemes.

In some examples, the one or more subfields collectively include at least five bits.

In some examples, the user info field is absent of a reserved subfield in accordance with the user info field including the one or more subfields that collectively include the at least five bits and including a subfield that jointly indicates a quantity of the set of multiple spatial streams and the pattern of modulation schemes.

In some examples, the user info field includes at least 22 bits.

In some examples, the user info field includes a reserved subfield in accordance with the user info field including the one or more subfields that collectively include the at least five bits and including a subfield that jointly indicates a quantity of the set of multiple spatial streams and the pattern of modulation schemes.

In some examples, the user info field includes at least 23 bits.

In some examples, the user info field is absent of a reserved subfield in accordance with the user info field including the one or more subfields that collectively include the at least five bits, including a first subfield that indicates a quantity of the set of multiple spatial streams, and including a second subfield that indicates the pattern of modulation schemes.

In some examples, the user info field includes at least 24 bits.

In some examples, the user info field includes a spatial stream allocation subfield that includes a set of multiple bits. In some examples, the set of multiple bits includes a first subset of bits and a second subset of bits. In some examples, the first subset of bits provides an indication of whether the user info field is associated with a non-MU-MIMO resource allocation or an MU-MIMO resource allocation.

In some examples, the second subset of bits is interpreted in accordance with whether the user info field is associated with the non-MU-MIMO resource allocation or the MU-MIMO resource allocation.

In some examples, the first subset of bits indicates that the user info field is associated with the non-MU-MIMO resource allocation. In some examples, the second subset of bits indicates a quantity of the set of multiple spatial streams and the pattern of modulation schemes associated with the communication between the first wireless communication device and the second wireless communication device.

In some examples, the second subset of bits separately indicates the quantity of the set of multiple spatial streams and the pattern of modulation schemes. In some examples, the second subset of bits jointly indicates the quantity of the set of multiple spatial streams and the pattern of modulation schemes.

In some examples, the user info field is included within a trigger frame.

In some examples, the user info field is associated with a non-MU-MIMO resource allocation and is included within an MU PPDU.

In some examples, the capability indication component 1140 is configurable or configured to communicate capability information with the second wireless communication device. In some examples, receiving the information indicative of the pattern of modulation schemes via the user info field is in accordance with the capability information.

FIG. 12 shows a flowchart illustrating an example process 1200 performable by or at a first wireless communication device that supports signaling designs for MCS indication. The operations of the process 1200 may be implemented by a first wireless communication device or its components. For example, the process 1200 may be performed by a wireless communication device, such as the wireless communication device 1000 described with reference to FIG. 10, operating as or within a wireless AP. In some examples, the process 1200 may be performed by a wireless AP, such as one of the APs 102 described with reference to FIG. 1.

In some examples, in block 1205, the first wireless communication device may transmit, via one or more subfields of a user info field associated with a second wireless communication device, information indicative of an MCS, from a set of multiple MCSs, associated with communication between the first wireless communication device and the second wireless communication device, where the one or more subfields collectively include at least five bits. The operations of block 1205 may be performed in accordance with examples as disclosed herein. In some implementations, aspects of the operations of block 1205 may be performed by an MCS indication component 1025 as described with reference to FIG. 10.

In some examples, in block 1210, the first wireless communication device may communicate with the second wireless communication device in accordance with the MCS. The operations of block 1210 may be performed in accordance with examples as disclosed herein. In some implementations, aspects of the operations of block 1210 may be performed by a communication component 1030 as described with reference to FIG. 10.

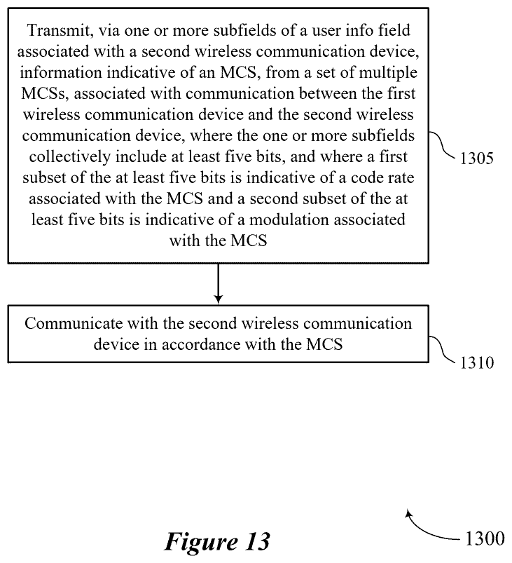

FIG. 13 shows a flowchart illustrating an example process 1300 performable by or at a first wireless communication device that supports signaling designs for MCS indication. The operations of the process 1300 may be implemented by a first wireless communication device or its components. For example, the process 1300 may be performed by a wireless communication device, such as the wireless communication device 1000 described with reference to FIG. 10, operating as or within a wireless AP. In some examples, the process 1300 may be performed by a wireless AP, such as one of the APs 102 described with reference to FIG. 1.

In some examples, in block 1305, the first wireless communication device may transmit, via one or more subfields of a user info field associated with a second wireless communication device, information indicative of an MCS, from a set of multiple MCSs, associated with communication between the first wireless communication device and the second wireless communication device, where the one or more subfields collectively include at least five bits, and where a first subset of the at least five bits is indicative of a code rate associated with the MCS and a second subset of the at least five bits is indicative of a modulation associated with the MCS. The operations of block 1305 may be performed in accordance with examples as disclosed herein. In some implementations, aspects of the operations of block 1305 may be performed by an MCS indication component 1025 as described with reference to FIG. 10.

In some examples, in block 1310, the first wireless communication device may communicate with the second wireless communication device in accordance with the MCS. The operations of block 1310 may be performed in accordance with examples as disclosed herein. In some implementations, aspects of the operations of block 1310 may be performed by a communication component 1030 as described with reference to FIG. 10.

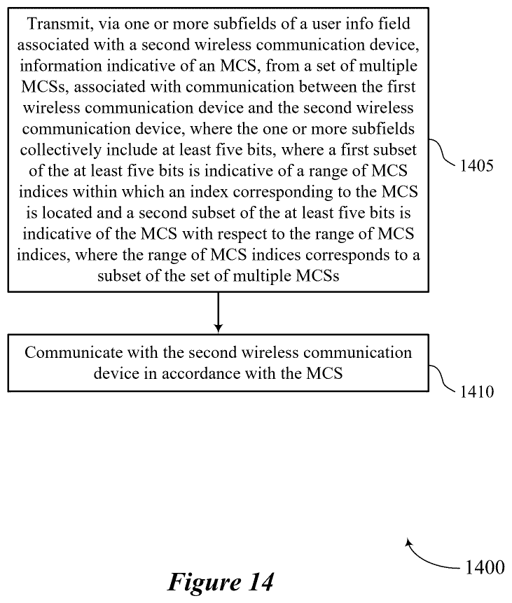

FIG. 14 shows a flowchart illustrating an example process 1400 performable by or at a first wireless communication device that supports signaling designs for MCS indication. The operations of the process 1400 may be implemented by a first wireless communication device or its components. For example, the process 1400 may be performed by a wireless communication device, such as the wireless communication device 1000 described with reference to FIG. 10, operating as or within a wireless AP. In some examples, the process 1400 may be performed by a wireless AP, such as one of the APs 102 described with reference to FIG. 1.

In some examples, in block 1405, the first wireless communication device may transmit, via one or more subfields of a user info field associated with a second wireless communication device, information indicative of an MCS, from a set of multiple MCSs, associated with communication between the first wireless communication device and the second wireless communication device, where the one or more subfields collectively include at least five bits, where a first subset of the at least five bits is indicative of a range of MCS indices within which an index corresponding to the MCS is located and a second subset of the at least five bits is indicative of the MCS with respect to the range of MCS indices, where the range of MCS indices corresponds to a subset of the set of multiple MCSs. The operations of block 1405 may be performed in accordance with examples as disclosed herein. In some implementations, aspects of the operations of block 1405 may be performed by an MCS indication component 1025 as described with reference to FIG. 10.

In some examples, in block 1410, the first wireless communication device may communicate with the second wireless communication device in accordance with the MCS. The operations of block 1410 may be performed in accordance with examples as disclosed herein. In some implementations, aspects of the operations of block 1410 may be performed by a communication component 1030 as described with reference to FIG. 10.

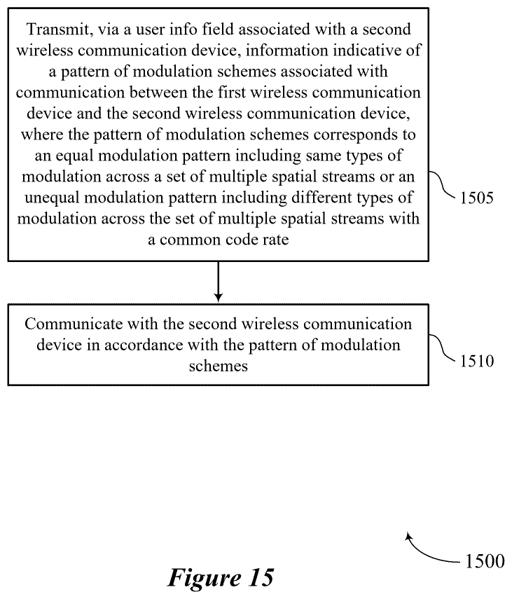

FIG. 15 shows a flowchart illustrating an example process 1500 performable by or at a first wireless communication device that supports signaling designs for (un) equal modulation indication. The operations of the process 1500 may be implemented by a first wireless communication device or its components. For example, the process 1500 may be performed by a wireless communication device, such as the wireless communication device 1000 described with reference to FIG. 10, operating as or within a wireless AP. In some examples, the process 1500 may be performed by a wireless AP, such as one of the APs 102 described with reference to FIG. 1.

In some examples, in block 1505, the first wireless communication device may transmit, via a user info field associated with a second wireless communication device, information indicative of a pattern of modulation schemes associated with communication between the first wireless communication device and the second wireless communication device, where the pattern of modulation schemes corresponds to an equal modulation pattern including same types of modulation across a set of multiple spatial streams or an unequal modulation pattern including different types of modulation across the set of multiple spatial streams with a common code rate. The operations of block 1505 may be performed in accordance with examples as disclosed herein. In some implementations, aspects of the operations of block 1505 may be performed by a modulation pattern indication component 1035 as described with reference to FIG. 10.

In some examples, in block 1510, the first wireless communication device may communicate with the second wireless communication device in accordance with the pattern of modulation schemes. The operations of block 1510 may be performed in accordance with examples as disclosed herein. In some implementations, aspects of the operations of block 1510 may be performed by a communication component 1030 as described with reference to FIG. 10.

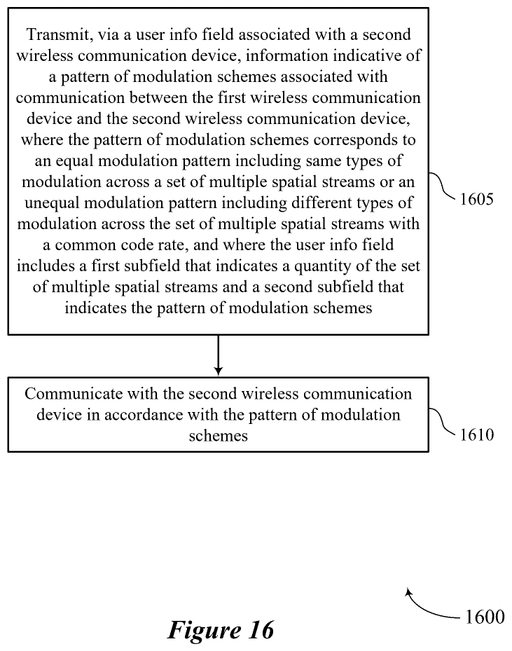

FIG. 16 shows a flowchart illustrating an example process 1600 performable by or at a first wireless communication device that supports signaling designs for (un) equal modulation indication. The operations of the process 1600 may be implemented by a first wireless communication device or its components. For example, the process 1600 may be performed by a wireless communication device, such as the wireless communication device 1000 described with reference to FIG. 10, operating as or within a wireless AP. In some examples, the process 1600 may be performed by a wireless AP, such as one of the APs 102 described with reference to FIG. 1.

In some examples, in block 1605, the first wireless communication device may transmit, via a user info field associated with a second wireless communication device, information indicative of a pattern of modulation schemes associated with communication between the first wireless communication device and the second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and where the user info field includes a first subfield that indicates a quantity of the set of multiple spatial streams and a second subfield that indicates the pattern of modulation schemes. The operations of block 1605 may be performed in accordance with examples as disclosed herein. In some implementations, aspects of the operations of block 1605 may be performed by a modulation pattern indication component 1035 as described with reference to FIG. 10.

In some examples, in block 1610, the first wireless communication device may communicate with the second wireless communication device in accordance with the pattern of modulation schemes. The operations of block 1610 may be performed in accordance with examples as disclosed herein. In some implementations, aspects of the operations of block 1610 may be performed by a communication component 1030 as described with reference to FIG. 10.

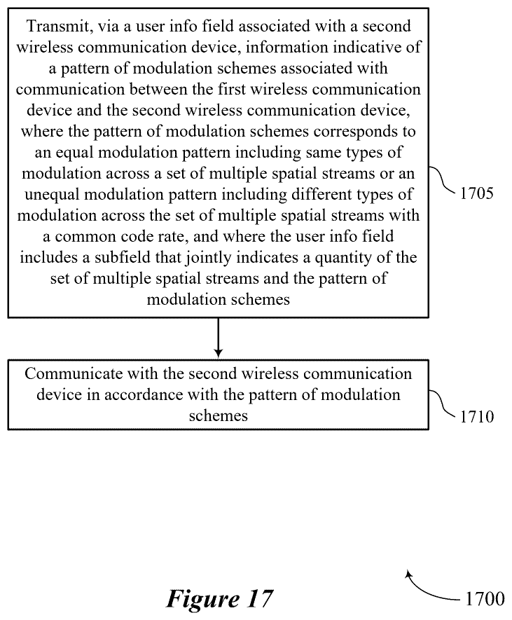

FIG. 17 shows a flowchart illustrating an example process 1700 performable by or at a first wireless communication device that supports signaling designs for (un) equal modulation indication. The operations of the process 1700 may be implemented by a first wireless communication device or its components. For example, the process 1700 may be performed by a wireless communication device, such as the wireless communication device 1000 described with reference to FIG. 10, operating as or within a wireless AP. In some examples, the process 1700 may be performed by a wireless AP, such as one of the APs 102 described with reference to FIG. 1.

In some examples, in block 1705, the first wireless communication device may transmit, via a user info field associated with a second wireless communication device, information indicative of a pattern of modulation schemes associated with communication between the first wireless communication device and the second wireless communication device, where the pattern of modulation schemes corresponds to an equal modulation pattern including same types of modulation across a set of multiple spatial streams or an unequal modulation pattern including different types of modulation across the set of multiple spatial streams with a common code rate, and where the user info field includes a subfield that jointly indicates a quantity of the set of multiple spatial streams and the pattern of modulation schemes. The operations of block 1705 may be performed in accordance with examples as disclosed herein. In some implementations, aspects of the operations of block 1705 may be performed by a modulation pattern indication component 1035 as described with reference to FIG. 10.

In some examples, in block 1710, the first wireless communication device may communicate with the second wireless communication device in accordance with the pattern of modulation schemes. The operations of block 1710 may be performed in accordance with examples as disclosed herein. In some implementations, aspects of the operations of block 1710 may be performed by a communication component 1030 as described with reference to FIG. 10.

FIG. 18 shows a flowchart illustrating an example process 1800 performable by or at a first wireless communication device that supports signaling designs for MCS indication. The operations of the process 1800 may be implemented by a first wireless communication device or its components. For example, the process 1800 may be performed by a wireless communication device, such as the wireless communication device 1100 described with reference to FIG. 11, operating as or within a wireless STA. In some examples, the process 1800 may be performed by a wireless STA, such as one of the STAs 104 described with reference to FIG. 1.

In some examples, in block 1805, the first wireless communication device may receive, via one or more subfields of a user info field associated with the first wireless communication device, information indicative of an MCS, from a set of multiple MCSs, associated with communication between the first wireless communication device and a second wireless communication device, where the one or more subfields collectively include at least five bits. The operations of block 1805 may be performed in accordance with examples as disclosed herein. In some implementations, aspects of the operations of block 1805 may be performed by an MCS indication component 1125 as described with reference to FIG. 11.

In some examples, in block 1810, the first wireless communication device may communicate with the second wireless communication device in accordance with the MCS. The operations of block 1810 may be performed in accordance with examples as disclosed herein. In some implementations, aspects of the operations of block 1810 may be performed by a communication component 1130 as described with reference to FIG. 11.

FIG. 19 shows a flowchart illustrating an example process 1900 performable by or at a first wireless communication device that supports signaling designs for (un) equal modulation indication. The operations of the process 1900 may be implemented by a first wireless communication device or its components. For example, the process 1900 may be performed by a wireless communication device, such as the wireless communication device 1100 described with reference to FIG. 11, operating as or within a wireless STA. In some examples, the process 1900 may be performed by a wireless STA, such as one of the STAs 104 described with reference to FIG. 1.

In some examples, in block 1905, the first wireless communication device may receive, via a user info field associated with the first wireless communication device, information indicative of a pattern of modulation schemes associated with communication between the first wireless communication device and a second wireless communication device, where the pattern of modulation schemes corresponds to an equal modulation pattern including same types of modulation across a set of multiple spatial streams or an unequal modulation pattern including different types of modulation across the set of multiple spatial streams with a common code rate. The operations of block 1905 may be performed in accordance with examples as disclosed herein. In some implementations, aspects of the operations of block 1905 may be performed by a modulation pattern indication component 1135 as described with reference to FIG. 11.

In some examples, in block 1910, the first wireless communication device may communicate with the second wireless communication device in accordance with the pattern of modulation schemes. The operations of block 1910 may be performed in accordance with examples as disclosed herein. In some implementations, aspects of the operations of block 1910 may be performed by a communication component 1130 as described with reference to FIG. 11.

Implementation examples are described in the following numbered clauses:

Clause 1: A method for wireless communication by a first wireless communication device, including: transmitting, via one or more subfields of a user info field associated with a second wireless communication device, information indicative of an MCS, from a plurality of MCSs, associated with communication between the first wireless communication device and the second wireless communication device, where the one or more subfields collectively include at least five bits; and communicating with the second wireless communication device in accordance with the MCS.

Clause 2: The method of clause 1, where a first subset of the at least five bits is indicative of a code rate associated with the MCS and a second subset of the at least five bits is indicative of a modulation associated with the MCS.

Clause 3: The method of clause 2, where the one or more subfields include a first subfield and a second subfield, and the first subfield includes the first subset of the at least five bits and the second subfield includes the second subset of the at least five bits.

Clause 4: The method of clause 3, where the first subfield includes two bits and the second subfield includes three bits.

Clause 5: The method of clause 1, where a first subset of the at least five bits is indicative of a range of MCS indices within which an index corresponding to the MCS is located and a second subset of the at least five bits is indicative of the MCS with respect to the range of MCS indices, the range of MCS indices corresponds to a subset of the plurality of MCSs.

Clause 6: The method of clause 5, where the one or more subfields consists of a single subfield, and the single subfield includes the first subset of the at least five bits and the second subset of the at least five bits.

Clause 7: The method of clause 5, where the one or more subfields include a first subfield and a second subfield, and the first subfield includes the first subset of the at least five bits and the second subfield includes the second subset of the at least five bits.

Clause 8: The method of any of clauses 5-7, where the first subset of the at least five bits includes one bit and the second subset of the at least five bits includes four bits.

Clause 9: The method of any of clauses 1-8, where the user info field includes second information indicative of a pattern of modulation schemes associated with the communication between the first wireless communication device and the second wireless communication device, the pattern of modulation schemes corresponds to an equal modulation pattern including same types of modulation across a plurality of spatial streams or an unequal modulation pattern including different types of modulation across the plurality of spatial streams with a common code rate, and communicating with the second wireless communication device is further in accordance with the pattern of modulation schemes.

Clause 10: The method of clause 9, where the MCS indicated by the user info field is an anchor MCS associated with the pattern of modulation schemes.

Clause 11: The method of any of clauses 9-10, where the second information includes a quantity of the plurality of spatial streams and the pattern of modulation schemes, and the user info field includes a subfield that jointly indicates the quantity of the plurality of spatial streams and the pattern of modulation schemes.

Clause 12: The method of clause 11, where the user info field is absent of a reserved subfield in accordance with the user info field including the one or more subfields that collectively include the at least five bits and including the subfield that jointly indicates the quantity of the plurality of spatial streams and the pattern of modulation schemes.

Clause 13: The method of clause 12, where the user info field includes at least 22 bits.

Clause 14: The method of any of clauses 11-13, where the user info field includes a reserved subfield in accordance with the user info field including the one or more subfields that collectively include the at least five bits and including the subfield that jointly indicates the quantity of the plurality of spatial streams and the pattern of modulation schemes.

Clause 15: The method of clause 14, where the user info field includes at least 23 bits.

Clause 16: The method of any of clauses 9-10, where the second information includes a quantity of the plurality of spatial streams and the pattern of modulation schemes, and the user info field includes a first subfield that indicates the quantity of the plurality of spatial streams and a second subfield that indicates the pattern of modulation schemes.

Clause 17: The method of clause 16, where the user info field is absent of a reserved subfield in accordance with the user info field including the one or more subfields that collectively include the at least five bits, including the first subfield that indicates the quantity of the plurality of spatial streams, and including the second subfield that indicates the pattern of modulation schemes.

Clause 18: The method of clause 17, where the user info field includes at least 24 bits.

Clause 19: The method of any of clauses 9-18, where the user info field is associated with a non-MU-MIMO resource allocation and is included within an MU PPDU.

Clause 20: The method of any of clauses 1-19, where the user info field includes a spatial stream allocation subfield that includes a plurality of bits, the plurality of bits includes a first subset of bits and a second subset of bits, and the first subset of bits provides an indication of whether the user info field is associated with a non-MU-MIMO resource allocation or an MU-MIMO resource allocation.

Clause 21: The method of clause 20, where the second subset of bits is interpreted in accordance with whether the user info field is associated with the non-MU-MIMO resource allocation or the MU-MIMO resource allocation.

Clause 22: The method of clause 21, where the first subset of bits indicates that the user info field is associated with the MU-MIMO resource allocation, and the second subset of bits indicates a starting spatial stream and a quantity of a plurality of spatial streams associated with the communication between the first wireless communication device and the second wireless communication device.

Clause 23: The method of clause 21, where the first subset of bits indicates that the user info field is associated with the non-MU-MIMO resource allocation, and the second subset of bits indicates a quantity of a plurality of spatial streams and a pattern of modulation schemes associated with the communication between the first wireless communication device and the second wireless communication device, the pattern of modulation schemes corresponds to an equal modulation pattern including same types of modulation across the plurality of spatial streams or an unequal modulation pattern including different types of modulation across the plurality of spatial streams with a common code rate.

Clause 24: The method of clause 23, where the second subset of bits separately indicates the quantity of the plurality of spatial streams and the pattern of modulation schemes, or the second subset of bits jointly indicates the quantity of the plurality of spatial streams and the pattern of modulation schemes.

Clause 25: The method of any of clauses 20-24, where the user info field is included within a trigger frame.

Clause 26: The method of any of clauses 1-25, further including: transmitting a first frame that includes the user info field associated with the second wireless communication device, where the user info field is associated with a non-MU-MIMO resource allocation, and where the plurality of MCSs are associated with the non-MU-MIMO resource allocation; and transmitting, via a second user info field of the first frame or a second frame, second information indicative of a second MCS, from a second plurality of MCSs, associated with second communication between the first wireless communication device and at least a third wireless communication device, where the second user info field is associated with an MU-MIMO resource allocation, and where the second plurality of MCSs are associated with the MU-MIMO resource allocation.

Clause 27: The method of clause 26, where an MCS subfield of the second user info field provides the second information via four bits, and the second user info field includes 22 bits.

Clause 28: The method of any of clauses 26-27, where the second plurality of MCSs is different than the plurality of MCSs, and the second plurality of MCSs includes at most 16 MCSs and the plurality of MCSs includes greater than 16 MCSs.

Clause 29: The method of any of clauses 1-28, further including: communicating capability information with the second wireless communication device, where transmitting the information indicative of the MCS via the one or more subfields that collectively include the at least five bits is in accordance with the capability information.

Clause 30: The method of any of clauses 1-29, where the user info field is used for communication in accordance with one or more of the IEEE 802.11 standards, the IEEE 802.15 standards, the Bluetooth SIG standards, or the LTE, 3G, 4G, 5G, and 6G standards promulgated by the 3GPP.

Clause 31: A method for wireless communication by a first wireless communication device, including: transmitting, via a user info field associated with a second wireless communication device, information indicative of a pattern of modulation schemes associated with communication between the first wireless communication device and the second wireless communication device, where the pattern of modulation schemes corresponds to an equal modulation pattern including same types of modulation across a plurality of spatial streams or an unequal modulation pattern including different types of modulation across the plurality of spatial streams with a common code rate; and communicating with the second wireless communication device in accordance with the pattern of modulation schemes.

Clause 32: The method of clause 31, where the user info field includes a first subfield that indicates a quantity of the plurality of spatial streams and a second subfield that indicates the pattern of modulation schemes.

Clause 33: The method of clause 32, where the second subfield is interpreted in accordance with the quantity of the plurality of spatial streams.

Clause 34: The method of any of clauses 32-33, where the second subfield includes a set of bits, and for a quantity of spatial streams, each respective permutation of the set of bits indicates a respective pattern of modulation schemes across the quantity of spatial streams or a validate state for the second subfield.

Clause 35: The method of clause 34, where a permutation of the set of bits indicates one of the equal modulation pattern or a specific unequal modulation pattern in accordance with the quantity of spatial streams being two, three, or four.

Clause 36: The method of any of clauses 34-35, where a permutation of the set of bits indicates one of the equal modulation pattern or the validate state for the second subfield in accordance with the quantity of spatial streams being one or greater than four.

Clause 37: The method of any of clauses 34-36, where the set of bits includes two bits.

Clause 38: The method of clause 31, where the user info field includes a subfield that jointly indicates a quantity of the plurality of spatial streams and the pattern of modulation schemes.

Clause 39: The method of clause 38, where the subfield includes a set of bits, and each respective permutation of the set of bits indicates a respective quantity of the plurality of spatial streams and a respective pattern of modulation schemes across the plurality of spatial streams.

Clause 40: The method of clause 39, where the set of bits includes four bits.

Clause 41: The method of any of clauses 31-40, where the user info field includes one or more subfields that include second information indicative of an MCS, from a plurality of MCSs, associated with the communication between the first wireless communication device and the second wireless communication device, and communicating with the second wireless communication device is further in accordance with the MCS.

Clause 42: The method of clause 41, where the MCS indicated by the user info field is an anchor MCS associated with the pattern of modulation schemes.

Clause 43: The method of any of clauses 41-42, where the one or more subfields collectively include at least five bits.

Clause 44: The method of clause 43, where the user info field is absent of a reserved subfield in accordance with the user info field including the one or more subfields that collectively include the at least five bits and including a subfield that jointly indicates a quantity of the plurality of spatial streams and the pattern of modulation schemes.

Clause 45: The method of clause 44, where the user info field includes at least 22 bits.

Clause 46: The method of clause 43, where the user info field includes a reserved subfield in accordance with the user info field including the one or more subfields that collectively include the at least five bits and including a subfield that jointly indicates a quantity of the plurality of spatial streams and the pattern of modulation schemes.

Clause 47: The method of clause 46, where the user info field includes at least 23 bits.

Clause 48: The method of clause 43, where the user info field is absent of a reserved subfield in accordance with the user info field including the one or more subfields that collectively include the at least five bits, including a first subfield that indicates a quantity of the plurality of spatial streams, and including a second subfield that indicates the pattern of modulation schemes.

Clause 49: The method of clause 48, where the user info field includes at least 24 bits.

Clause 50: The method of any of clauses 31-49, where the user info field includes a spatial stream allocation subfield that includes a plurality of bits, the plurality of bits includes a first subset of bits and a second subset of bits, and the first subset of bits provides an indication of whether the user info field is associated with a non-MU-MIMO resource allocation or an MU-MIMO resource allocation.

Clause 51: The method of clause 50, where the second subset of bits is interpreted in accordance with whether the user info field is associated with the non-MU-MIMO resource allocation or the MU-MIMO resource allocation.

Clause 52: The method of clause 51, where the first subset of bits indicates that the user info field is associated with the non-MU-MIMO resource allocation, and the second subset of bits indicates a quantity of the plurality of spatial streams and the pattern of modulation schemes associated with the communication between the first wireless communication device and the second wireless communication device.

Clause 53: The method of clause 52, where the second subset of bits separately indicates the quantity of the plurality of spatial streams and the pattern of modulation schemes, or the second subset of bits jointly indicates the quantity of the plurality of spatial streams and the pattern of modulation schemes.

Clause 54: The method of any of clauses 50-53, where the user info field is included within a trigger frame.

Clause 55: The method of any of clauses 31-54, where the user info field is associated with a non-MU-MIMO resource allocation and is included within an MU PPDU.

Clause 56: The method of any of clauses 31-55, further including: communicating capability information with the second wireless communication device, where transmitting the information indicative of the pattern of modulation schemes via the user info field is in accordance with the capability information.

Clause 57: The method of any of clauses 31-56, where the user info field is used for communication in accordance with one or more of the IEEE 802.11 standards, the IEEE 802.15 standards, the Bluetooth SIG standards, or the LTE, 3G, 4G, 5G, and 6G standards promulgated by the 3GPP.

Clause 58: A method for wireless communication by a first wireless communication device, including: receiving, via one or more subfields of a user info field associated with the first wireless communication device, information indicative of an MCS, from a plurality of MCSs, associated with communication between the first wireless communication device and a second wireless communication device, where the one or more subfields collectively include at least five bits; and communicating with the second wireless communication device in accordance with the MCS.

Clause 59: The method of clause 58, where a first subset of the at least five bits is indicative of a code rate associated with the MCS and a second subset of the at least five bits is indicative of a modulation associated with the MCS.

Clause 60: The method of clause 59, where the one or more subfields include a first subfield and a second subfield, and the first subfield includes the first subset of the at least five bits and the second subfield includes the second subset of the at least five bits.

Clause 61: The method of clause 60, where the first subfield includes two bits and the second subfield includes three bits.

Clause 62: The method of clause 58, where a first subset of the at least five bits is indicative of a range of MCS indices within which an index corresponding to the MCS is located and a second subset of the at least five bits is indicative of the MCS with respect to the range of MCS indices, the range of MCS indices corresponds to a subset of the plurality of MCSs.

Clause 63: The method of clause 62, where the one or more subfields consists of a single subfield, and the single subfield includes the first subset of the at least five bits and the second subset of the at least five bits.

Clause 64: The method of clause 62, where the one or more subfields include a first subfield and a second subfield, and the first subfield includes the first subset of the at least five bits and the second subfield includes the second subset of the at least five bits.

Clause 65: The method of any of clauses 62-64, where the first subset of the at least five bits includes one bit and the second subset of the at least five bits includes four bits.

Clause 66: The method of any of clauses 58-65, where the user info field includes second information indicative of a pattern of modulation schemes associated with the communication between the first wireless communication device and the second wireless communication device, the pattern of modulation schemes corresponds to an equal modulation pattern including same types of modulation across a plurality of spatial streams or an unequal modulation pattern including different types of modulation across the plurality of spatial streams with a common code rate, and communicating with the second wireless communication device is further in accordance with the pattern of modulation schemes.

Clause 67: The method of clause 66, where the MCS indicated by the user info field is an anchor MCS associated with the pattern of modulation schemes.

Clause 68: The method of any of clauses 66-67, where the second information includes a quantity of the plurality of spatial streams and the pattern of modulation schemes, and the user info field includes a subfield that jointly indicates the quantity of the plurality of spatial streams and the pattern of modulation schemes.

Clause 69: The method of clause 68, where the user info field is absent of a reserved subfield in accordance with the user info field including the one or more subfields that collectively include the at least five bits and including the subfield that jointly indicates the quantity of the plurality of spatial streams and the pattern of modulation schemes.

Clause 70: The method of clause 69, where the user info field includes at least 22 bits.

Clause 71: The method of any of clauses 68-70, where the user info field includes a reserved subfield in accordance with the user info field including the one or more subfields that collectively include the at least five bits and including the subfield that jointly indicates the quantity of the plurality of spatial streams and the pattern of modulation schemes.

Clause 72: The method of clause 71, where the user info field includes at least 23 bits.

Clause 73: The method of any of clauses 66-67, where the second information includes a quantity of the plurality of spatial streams and the pattern of modulation schemes, and the user info field includes a first subfield that indicates the quantity of the plurality of spatial streams and a second subfield that indicates the pattern of modulation schemes.

Clause 74: The method of clause 73, where the user info field is absent of a reserved subfield in accordance with the user info field including the one or more subfields that collectively include the at least five bits, including the first subfield that indicates the quantity of the plurality of spatial streams, and including the second subfield that indicates the pattern of modulation schemes.

Clause 75: The method of clause 74, where the user info field includes at least 24 bits.

Clause 76: The method of any of clauses 66-75, where the user info field is associated with a non-MU-MIMO resource allocation and is included within an MU PPDU.

Clause 77: The method of any of clauses 58-76, where the user info field includes a spatial stream allocation subfield that includes a plurality of bits, the plurality of bits includes a first subset of bits and a second subset of bits, and the first subset of bits provides an indication of whether the user info field is associated with a non-MU-MIMO resource allocation or an MU-MIMO resource allocation.

Clause 78: The method of clause 77, where the second subset of bits is interpreted in accordance with whether the user info field is associated with the non-MU-MIMO resource allocation or the MU-MIMO resource allocation.

Clause 79: The method of clause 78, where the first subset of bits indicates that the user info field is associated with the MU-MIMO resource allocation, and the second subset of bits indicates a starting spatial stream and a quantity of a plurality of spatial streams associated with the communication between the first wireless communication device and the second wireless communication device.

Clause 80: The method of clause 78, where the first subset of bits indicates that the user info field is associated with the non-MU-MIMO resource allocation, and the second subset of bits indicates a quantity of a plurality of spatial streams and a pattern of modulation schemes associated with the communication between the first wireless communication device and the second wireless communication device, the pattern of modulation schemes corresponds to an equal modulation pattern including same types of modulation across the plurality of spatial streams or an unequal modulation pattern including different types of modulation across the plurality of spatial streams with a common code rate.

Clause 81: The method of clause 80, where the second subset of bits separately indicates the quantity of the plurality of spatial streams and the pattern of modulation schemes, or the second subset of bits jointly indicates the quantity of the plurality of spatial streams and the pattern of modulation schemes.

Clause 82: The method of any of clauses 77-81, where the user info field is included within a trigger frame.

Clause 83: The method of any of clauses 58-82, further including: receiving a first frame that includes the user info field associated with the first wireless communication device, where the user info field is associated with a non-MU-MIMO resource allocation, and where the plurality of MCSs are associated with the non-MU-MIMO resource allocation; and receiving, via a second user info field of the first frame or a second frame, second information indicative of a second MCS, from a second plurality of MCSs, associated with second communication between at least the first wireless communication device and the second wireless communication device, where the second user info field is associated with an MU-MIMO resource allocation, and where the second plurality of MCSs are associated with the MU-MIMO resource allocation.

Clause 84: The method of clause 83, where an MCS subfield of the second user info field provides the second information via four bits, and the second user info field includes 22 bits.

Clause 85: The method of any of clauses 83-84, where the second plurality of MCSs is different than the plurality of MCSs, and the second plurality of MCSs includes at most 16 MCSs and the plurality of MCSs includes greater than 16 MCSs.

Clause 86: The method of any of clauses 58-85, further including: communicating capability information with the second wireless communication device, where receiving the information indicative of the MCS via the one or more subfields that collectively include the at least five bits is in accordance with the capability information.

Clause 87: The method of any of clauses 58-86, where the user info field is used for communication in accordance with one or more of the IEEE 802.11 standards, the IEEE 802.15 standards, the Bluetooth SIG standards, or the LTE, 3G, 4G, 5G, and 6G standards promulgated by the 3GPP.

Clause 88: A method for wireless communication by a first wireless communication device, including: receiving, via a user info field associated with the first wireless communication device, information indicative of a pattern of modulation schemes associated with communication between the first wireless communication device and a second wireless communication device, where the pattern of modulation schemes corresponds to an equal modulation pattern including same types of modulation across a plurality of spatial streams or an unequal modulation pattern including different types of modulation across the plurality of spatial streams with a common code rate; and communicating with the second wireless communication device in accordance with the pattern of modulation schemes.

Clause 89: The method of clause 88, where the user info field includes a first subfield that indicates a quantity of the plurality of spatial streams and a second subfield that indicates the pattern of modulation schemes.

Clause 90: The method of clause 89, where the second subfield is interpreted in accordance with the quantity of the plurality of spatial streams.

Clause 91: The method of any of clauses 89-90, where the second subfield includes a set of bits, and for a quantity of spatial streams, each respective permutation of the set of bits indicates a respective pattern of modulation schemes across the quantity of spatial streams or a validate state for the second subfield.

Clause 92: The method of clause 91, where a permutation of the set of bits indicates one of the equal modulation pattern or a specific unequal modulation pattern in accordance with the quantity of spatial streams being two, three, or four.

Clause 93: The method of any of clauses 91-92, where a permutation of the set of bits indicates one of the equal modulation pattern or the validate state for the second subfield in accordance with the quantity of spatial streams being one or greater than four.

Clause 94: The method of any of clauses 91-93, where the set of bits includes two bits.

Clause 95: The method of clause 88, where the user info field includes a subfield that jointly indicates a quantity of the plurality of spatial streams and the pattern of modulation schemes.

Clause 96: The method of clause 95, where the subfield includes a set of bits, and each respective permutation of the set of bits indicates a respective quantity of the plurality of spatial streams and a respective pattern of modulation schemes across the plurality of spatial streams.

Clause 97: The method of clause 96, where the set of bits includes four bits.

Clause 98: The method of any of clauses 88-97, where the user info field includes one or more subfields that include second information indicative of an MCS, from a plurality of MCSs, associated with the communication between the first wireless communication device and the second wireless communication device, and communicating with the second wireless communication device is further in accordance with the MCS.

Clause 99: The method of clause 98, where the MCS indicated by the user info field is an anchor MCS associated with the pattern of modulation schemes.

Clause 100: The method of any of clauses 98-99, where the one or more subfields collectively include at least five bits.

Clause 101: The method of clause 100, where the user info field is absent of a reserved subfield in accordance with the user info field including the one or more subfields that collectively include the at least five bits and including a subfield that jointly indicates a quantity of the plurality of spatial streams and the pattern of modulation schemes.

Clause 102: The method of clause 101, where the user info field includes at least 22 bits.

Clause 103: The method of clause 100, where the user info field includes a reserved subfield in accordance with the user info field including the one or more subfields that collectively include the at least five bits and including a subfield that jointly indicates a quantity of the plurality of spatial streams and the pattern of modulation schemes.

Clause 104: The method of clause 103, where the user info field includes at least 23 bits.

Clause 105: The method of clause 100, where the user info field is absent of a reserved subfield in accordance with the user info field including the one or more subfields that collectively include the at least five bits, including a first subfield that indicates a quantity of the plurality of spatial streams, and including a second subfield that indicates the pattern of modulation schemes.

Clause 106: The method of clause 105, where the user info field includes at least 24 bits.

Clause 107: The method of any of clauses 88-106, where the user info field includes a spatial stream allocation subfield that includes a plurality of bits, the plurality of bits includes a first subset of bits and a second subset of bits, and the first subset of bits provides an indication of whether the user info field is associated with a non-MU-MIMO resource allocation or an MU-MIMO resource allocation.

Clause 108: The method of clause 107, where the second subset of bits is interpreted in accordance with whether the user info field is associated with the non-MU-MIMO resource allocation or the MU-MIMO resource allocation.

Clause 109: The method of clause 108, where the first subset of bits indicates that the user info field is associated with the non-MU-MIMO resource allocation, and the second subset of bits indicates a quantity of the plurality of spatial streams and the pattern of modulation schemes associated with the communication between the first wireless communication device and the second wireless communication device.

Clause 110: The method of clause 109, where the second subset of bits separately indicates the quantity of the plurality of spatial streams and the pattern of modulation schemes, or the second subset of bits jointly indicates the quantity of the plurality of spatial streams and the pattern of modulation schemes.

Clause 111: The method of any of clauses 107-110, where the user info field is included within a trigger frame.

Clause 112: The method of any of clauses 88-111, where the user info field is associated with a non-MU-MIMO resource allocation and is included within an MU PPDU.

Clause 113: The method of any of clauses 88-112, further including: communicating capability information with the second wireless communication device, where receiving the information indicative of the pattern of modulation schemes via the user info field is in accordance with the capability information.

Clause 114: The method of any of clauses 88-113, where the user info field is used for communication in accordance with one or more of the IEEE 802.11 standards, the IEEE 802.15 standards, the Bluetooth SIG standards, or the LTE, 3G, 4G, 5G, and 6G standards promulgated by the 3GPP.

Clause 115: A first wireless communication device for wireless communication, including a processing system that includes processor circuitry and memory circuitry that stores code, the processing system configured to cause the first wireless communication device to perform a method of any of clauses 1-30.

Clause 116: A first wireless communication device for wireless communication, including at least one means for performing a method of any of clauses 1-30.

Clause 117: A non-transitory computer-readable medium storing code for wireless communication, the code including instructions executable by one or more processors (such as a processing system) to perform a method of any of clauses 1-30.

Clause 118: A first wireless communication device for wireless communication, including a processing system that includes processor circuitry and memory circuitry that stores code, the processing system configured to cause the first wireless communication device to perform a method of any of clauses 31-57.

Clause 119: A first wireless communication device for wireless communication, including at least one means for performing a method of any of clauses 31-57.

Clause 120: A non-transitory computer-readable medium storing code for wireless communication, the code including instructions executable by one or more processors (such as a processing system) to perform a method of any of clauses 31-57.

Clause 121: A first wireless communication device for wireless communication, including a processing system that includes processor circuitry and memory circuitry that stores code, the processing system configured to cause the first wireless communication device to perform a method of any of clauses 58-87.

Clause 122: A first wireless communication device for wireless communication, including at least one means for performing a method of any of clauses 58-87.

Clause 123: A non-transitory computer-readable medium storing code for wireless communication, the code including instructions executable by one or more processors (such as a processing system) to perform a method of any of clauses 58-87.

Clause 124: A first wireless communication device for wireless communication, including a processing system that includes processor circuitry and memory circuitry that stores code, the processing system configured to cause the first wireless communication device to perform a method of any of clauses 88-114.

Clause 125: A first wireless communication device for wireless communication, including at least one means for performing a method of any of clauses 88-114.

Clause 126: A non-transitory computer-readable medium storing code for wireless communication, the code including instructions executable by one or more processors (such as a processing system) to perform a method of any of clauses 88-114.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. The claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
transmit, via one or more subfields of a user info field associated with a second wireless communication device, information indicative of a modulation and coding scheme (MCS), from a plurality of MCSs, associated with communication between the first wireless communication device and the second wireless communication device, wherein the one or more subfields collectively comprise at least five bits; and
communicate with the second wireless communication device in accordance with the MCS.

2. The first wireless communication device of claim 1, wherein a first subset of the at least five bits is indicative of a code rate associated with the MCS and a second subset of the at least five bits is indicative of a modulation associated with the MCS.

3. The first wireless communication device of claim 2, wherein:
the one or more subfields include a first subfield and a second subfield; and
the first subfield includes the first subset of the at least five bits and the second subfield includes the second subset of the at least five bits.

4. The first wireless communication device of claim 3, wherein the first subfield includes two bits and the second subfield includes three bits.

5. The first wireless communication device of claim 1, wherein:
a first subset of the at least five bits is indicative of a range of MCS indices within which an index corresponding to the MCS is located and a second subset of the at least five bits is indicative of the MCS with respect to the range of MCS indices; and
the range of MCS indices corresponds to a subset of the plurality of MCSs.

6. The first wireless communication device of claim 5, wherein:
the one or more subfields consists of a single subfield; and
the single subfield includes the first subset of the at least five bits and the second subset of the at least five bits.

7. The first wireless communication device of claim 5, wherein:
the one or more subfields include a first subfield and a second subfield; and
the first subfield includes the first subset of the at least five bits and the second subfield includes the second subset of the at least five bits.

8. The first wireless communication device of claim 5, wherein the first subset of the at least five bits includes one bit and the second subset of the at least five bits includes four bits.

9. The first wireless communication device of claim 1, wherein:
the user info field includes second information indicative of a pattern of modulation schemes associated with the communication between the first wireless communication device and the second wireless communication device;
the pattern of modulation schemes corresponds to an equal modulation pattern comprising same types of modulation across a plurality of spatial streams or an unequal modulation pattern comprising different types of modulation across the plurality of spatial streams with a common code rate; and
communicating with the second wireless communication device is further in accordance with the pattern of modulation schemes.

10. The first wireless communication device of claim 9, wherein the MCS indicated by the user info field is an anchor MCS associated with the pattern of modulation schemes.

11. The first wireless communication device of claim 9, wherein the second information comprises a quantity of the plurality of spatial streams and the pattern of modulation schemes, and the user info field includes a subfield that jointly indicates the quantity of the plurality of spatial streams and the pattern of modulation schemes.

12. The first wireless communication device of claim 9, wherein the second information comprises a quantity of the plurality of spatial streams and the pattern of modulation schemes, and the user info field includes a first subfield that indicates the quantity of the plurality of spatial streams and a second subfield that indicates the pattern of modulation schemes.

13. A first wireless communication device, comprising:
a processing system that includes processor circuitry and memory circuitry that stores code, the processing system configured to cause the first wireless communication device to:
receive, via one or more subfields of a user info field associated with the first wireless communication device, information indicative of a modulation and coding scheme (MCS), from a plurality of MCSs, associated with communication between the first wireless communication device and a second wireless communication device, wherein the one or more subfields collectively comprise at least five bits; and
communicate with the second wireless communication device in accordance with the MCS.

14. The first wireless communication device of claim 13, wherein a first subset of the at least five bits is indicative of a code rate associated with the MCS and a second subset of the at least five bits is indicative of a modulation associated with the MCS.

15. The first wireless communication device of claim 14, wherein:
the one or more subfields include a first subfield and a second subfield; and
the first subfield includes the first subset of the at least five bits and the second subfield includes the second subset of the at least five bits.

16. The first wireless communication device of claim 15, wherein the first subfield includes two bits and the second subfield includes three bits.

17. The first wireless communication device of claim 13, wherein:
a first subset of the at least five bits is indicative of a range of MCS indices within which an index corresponding to the MCS is located and a second subset of the at least five bits is indicative of the MCS with respect to the range of MCS indices; and
the range of MCS indices corresponds to a subset of the plurality of MCSs.

18. The first wireless communication device of claim 17, wherein:
the one or more subfields consists of a single subfield; and
the single subfield includes the first subset of the at least five bits and the second subset of the at least five bits.

19. The first wireless communication device of claim 17, wherein:
the one or more subfields include a first subfield and a second subfield; and
the first subfield includes the first subset of the at least five bits and the second subfield includes the second subset of the at least five bits.

20. The first wireless communication device of claim 17, wherein the first subset of the at least five bits includes one bit and the second subset of the at least five bits includes four bits.

21. The first wireless communication device of claim 13, wherein:
the user info field includes second information indicative of a pattern of modulation schemes associated with the communication between the first wireless communication device and the second wireless communication device;
the pattern of modulation schemes corresponds to an equal modulation pattern comprising same types of modulation across a plurality of spatial streams or an unequal modulation pattern comprising different types of modulation across the plurality of spatial streams with a common code rate; and
communicating with the second wireless communication device is further in accordance with the pattern of modulation schemes.

22. The first wireless communication device of claim 21, wherein the MCS indicated by the user info field is an anchor MCS associated with the pattern of modulation schemes.

23. The first wireless communication device of claim 21, wherein the second information comprises a quantity of the plurality of spatial streams and the pattern of modulation schemes, and the user info field includes a subfield that jointly indicates the quantity of the plurality of spatial streams and the pattern of modulation schemes.

24. The first wireless communication device of claim 21, wherein the second information comprises a quantity of the plurality of spatial streams and the pattern of modulation schemes, and the user info field includes a first subfield that indicates the quantity of the plurality of spatial streams and a second subfield that indicates the pattern of modulation schemes.

25. A method for wireless communication by a first wireless communication device, comprising:
transmitting, via one or more subfields of a user info field associated with a second wireless communication device, information indicative of a modulation and coding scheme (MCS), from a plurality of MCSs, associated with communication between the first wireless communication device and the second wireless communication device, wherein the one or more subfields collectively comprise at least five bits; and
communicating with the second wireless communication device in accordance with the MCS.

26. The method of claim 25, wherein a first subset of the at least five bits is indicative of a code rate associated with the MCS and a second subset of the at least five bits is indicative of a modulation associated with the MCS.

27. The method of claim 25, wherein:
a first subset of the at least five bits is indicative of a range of MCS indices within which an index corresponding to the MCS is located and a second subset of the at least five bits is indicative of the MCS with respect to the range of MCS indices; and
the range of MCS indices corresponds to a subset of the plurality of MCSs.

28. A method for wireless communication by a first wireless communication device, comprising:
receiving, via one or more subfields of a user info field associated with the first wireless communication device, information indicative of a modulation and coding scheme (MCS), from a plurality of MCSs, associated with communication between the first wireless communication device and a second wireless communication device, wherein the one or more subfields collectively comprise at least five bits; and
communicating with the second wireless communication device in accordance with the MCS.

29. The method of claim 28, wherein a first subset of the at least five bits is indicative of a code rate associated with the MCS and a second subset of the at least five bits is indicative of a modulation associated with the MCS.

30. The method of claim 28, wherein:
a first subset of the at least five bits is indicative of a range of MCS indices within which an index corresponding to the MCS is located and a second subset of the at least five bits is indicative of the MCS with respect to the range of MCS indices; and
the range of MCS indices corresponds to a subset of the plurality of MCSs.
